(19) United States
(12) Patent Application Publication
(10) Pub. No.: US 2026/0226204 A1
(43) Pub. Date: Aug. 6, 2026

(54) Method Of Making Catechol Styrene Co-Polymer

(71) Applicant: Mussel Polymers, Inc., Bethlehem, PA (US)

(72) Inventors: Robert J. Tenuto, Allentown, PA (US); Chester Crane, Bethlehem, PA (US); Jason Stieg, Lafayette Hill, PA (US)

(21) Appl. No.: 19/150,798

(22) PCT Filed: Jan. 24, 2024
(86) PCT No.: PCT/US2024/012759

§ 371 Date: Jul. 24, 2025

Related U.S. Application Data
(60) Provisional application No. 63/481,245, filed on Jan. 24, 2023.

(51) Int. Cl. C08F 8/00

(52) U.S. Cl. CPC C08F 8/00

(57) ABSTRACT

Poly(catechol-styrene) (PCS) is a new material that has a variety of industrial and biomedical uses. For example, PCS acts as an adhesive that functions in wet or underwater environments and accordingly may be useful for biomedical applications. The disclosure provides a method of forming a poly(catechol-styrene) polymer. The method comprises the steps of polymerizing 3,4-diacetoxystyrene and styrene in an emulsion polymerization to form a poly(3,4-diacetoxystyrene-co-styrene) polymer. This polymer has the acetate groups deprotected from the alcohols resulting to form poly(catechol-styrene) polymer. The poly(catechol-styrene) polymer has improved strength at higher molecular weight.

### CROSS-REFERENCE TO RELATED APPLICATION

This application claims the benefit of U.S. Provisional Application No. 63/481,245, filed on Jan. 24, 2023, the entirety of which is incorporated by reference herein.

### BACKGROUND

Poly(catechol-styrene) (PCS) is a new material that has a variety of industrial and biomedical uses. For example, PCS acts as an adhesive that functions in wet or underwater environments and may be useful for a range of applications. The challenge is producing PCS with an economically viable process. In order to incorporate the catechol moiety into PCS, the catechol hydroxyl groups must be protected prior to polymerizing. The free hydroxyls of the catechol act as radical scavengers and can have adverse effects on the polymerization such as cross linking, unexpected molecular weights, etc.

Most known polystyrene processes (and styrenic copolymers) use RAFT or solvent based anionic polymerization methods. The challenges with these types of polymerizations is that they are slow, and don't go to full conversion. Large scale polystyrene processes (and styrenic copolymers) are done using solvent polymerization, but only typically result in 90% monomer conversion. For most commercially available styrene copolymers, this extent of monomer conversion is not a problem. At the end of such processes, multistage extraction/extrusion is used to bring the polymer above its melting point, volatilize all of the impurities, and extrude the pure polymer. The problem with applying these processes to the production of PCS is that PCS is sensitive to heat and oxygen (and especially both together). As a result, it is critical that a commercially viable PCS production polymerization method achieve close to 100% monomer conversion.

### BRIEF SUMMARY

The disclosure provides methods of forming a poly(catechol-styrene) polymer. The method comprises the steps of polymerizing 3,4-diacetoxystyrene and styrene in an emulsion polymerization to form a poly(3,4-diacetoxystyrene-co-styrene) polymer. This polymer has the acetate groups deprotected from the alcohols to form poly(catechol-styrene) polymer. The poly(catechol-styrene) polymer has improved strength at higher molecular weight.

### BRIEF DESCRIPTION OF THE FIGURES

The accompanying drawings, which are incorporated in and constitute a part of this specification, illustrate embodiments, and together with the general description given above, and the detailed description of the embodiments given below, serve to explain the principles of the present disclosure.

FIG. 1 is a graph of the molecular weight of the resulting polymer based on the amounts of initiator used during the polymerization; Example 3.

FIG. 2 is a graph of the molecular weight of the resulting polymer based on the amounts of chain transfer agent used during the polymerization, Example 3.

FIG. 3 is a table showing the dry adhesion strength of poly(catechol-styrene) polymer made by processes using diacetoxy and methoxy protecting groups were compared along with their molecular weights; Example 6.

FIG. 4 is a table showing the wet adhesion strength of poly(catechol-styrene) polymer made by processes using diacetoxy and methoxy protecting groups were compared along with their molecular weights; Example 7.

### DETAILED DESCRIPTION

The disclosure provides a scalable process may be used to produce poly(catechol-styrene) using relatively inexpensive raw materials. Caffeic acid is naturally occurring in nearly all plant species and is a readily available starting material. Caffeic acid can undergo a one pot decarboxylation and hydroxyl protection to form a catechol containing monomer. The use of acid labile protecting groups, such as acetates, allow the catechol moiety to be freed post-polymerization under inexpensive, mild conditions.

In some aspects, the disclosure is directed to methods of forming a poly(catechol-styrene) polymer comprising the steps of:
(i) polymerizing 3,4-diacetoxystyrene and styrene to form a poly(3,4-diacetoxystyrene-co-styrene) polymer, and
(ii) deprotecting the acetate groups of the resulting poly(3,4-diacetoxystyrene-co-styrene) polymer to form poly(catechol-styrene) polymer.

In some aspects, the disclosure is directed to methods of forming a poly(catechol-styrene) polymer comprising the steps of:
(i) polymerizing 3,4-diacetoxystyrene and styrene in an emulsion polymerization to form a poly(3,4-diacetoxystyrene-co-styrene) polymer, and
(ii) deprotecting the acetate groups of the resulting poly(3,4-diacetoxystyrene-co-styrene) polymer to form poly(catechol-styrene) polymer.

In some embodiments, 3,4-Diacetoxystyrene (DAS) monomer is co-polymerized with styrene monomer via an emulsion polymerization technique as shown in Scheme I.

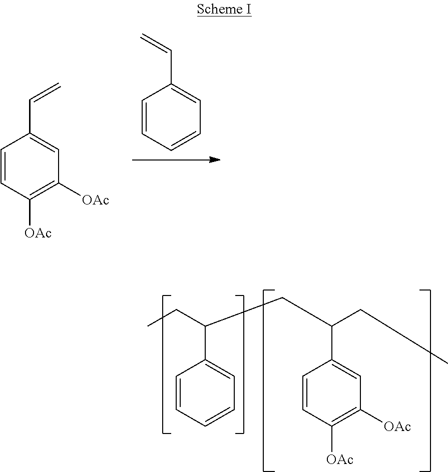

In some embodiments of the emulsion polymerization, the monomers that are polymerized are 3,4-diacetoxystyrene (DAS) monomer and styrene. Methods of making DAS are known in the art.

The ratio of the 3,4-diacetoxystyrene (DAS) monomer to the styrene monomer will affect the relative amounts of these moieties in the resulting poly(3,4-diacetoxystyrene-co-styrene) polymer and final product, poly(catechol-styrene) polymer. In some embodiments, the polymerization reaction additionally comprises monomers with fatty acid chains, such that the polymerization reaction produces a modified PCS.

In some embodiments, the weight ratio of styrene monomer to DAS monomer used in the polymerization reaction is between about 0.1 to about 5.0, such as, for example, about 0.1, about 0.11, about 0.12, about 0.13, about 0.14, about 0.15, about 0.16, about 0.17, about 0.18, about 0.19, about 0.20, about 0.21, about 0.22, about 0.23, about 0.24, about 0.25, about 0.26, about 0.27, about 0.28, about 0.29, about 0.30, about 0.31, about 032, about 0.33, about 0.34, about 0.35, about 0.36, about 0.37, about 0.38, about 0.39, about 0.40, about 0.41, about 0.42, about 0.43, about 0.44, about 0.45, about 0.46, about 0.47, about 0.48, about 0.49, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90, about 0.91, about 0.92, about 0.93, about 0.94, about 0.95, about 0.96, about 0.97, about 0.98, about 0.99, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, about 4.0, about 4.1, about 4.2, about 4.3, about 4.4, about 4.5, about 4.6, about 4.7, about 4.8, about 4.9, or about 5.0.

In some embodiments, the weight ratio of styrene monomer to DAS monomer used in the polymerization reaction is between about 1.1 to about 1.9, such as, for example, about 1.10, about 1.11, about 1.12, about 1.13, about 1.14, about 1.15, about 1.16, about 1.17, about 1.18, about 1.19, about 1.20, about 1.21, about 1.22, about 1.23, about 1.24, about 1.25, about 1.26, about 1.27, about 1.28, about 1.29, about 1.30, about 1.31, about 1.32, about 1.33, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, about 1.60, about 1.61, about 1.62, about 1.63, about 1.64, about 1.65, about 1.66, about 1.67, about 1.68, about 1.69, about 1.70, about 1.71, about 1.72, about 1.73, about 1.74, about 1.75, about 1.76, about 1.77, about 1.78, about 1.79, about 1.80, about 1.81, about 1.82, about 1.83, about 1.84, about 1.85, about 1.86, about 1.87, about 1.88, about 1.89, or about 1.90.

In other embodiments, the weight ratio of styrene monomer to DAS monomer used in the polymerization reaction is between about 1.4 to about 1.5, such as, for example, about 1.40, about 1.41, about 1.42, about 1.43, about 1.44, about 1.45, about 1.46, about 1.47, about 1.48, about 1.49, or about 1.50.

In some embodiments of the emulsion polymerization, the monomers are mixed with a surfactant, initiator, and a chain transfer agent.

In some embodiments of the emulsion polymerization, the monomers are mixed with a surfactant, such as, for example, an anionic surfactant, a cationic surfactant, a non-ionic surfactant, or any combination thereof. In some embodiments of the emulsion polymerization, the surfactant is sodium lauryl sulfate (i.e., sodium dodecyl sulfate), other sulfates, carboxylic acids (e.g., fatty acids), sulfonic esters, and phosphorous compounds. Other examples include alkyl alcohols, such as, for example, cetyl alcohol.

In some embodiments, the ratio of surfactant to total monomer, expressed as a percentage, is between about 0.2% to about 6.0%, such as, for example, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, or about 6.0%. As used herein, the percentage is calculated as (weight of surfactant)/(weight of DAS+weight of styrene)*100.

In some embodiments, the ratio of surfactant to total monomer, expressed as a percentage, is between about 0.8% to about 3.0%, such as, for example, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0%. In some embodiments, the ratio of sodium lauryl sulfate to total monomer, expressed as a percentage, is between about 1.2% to about 1.4%, such as, for example, about 1.20%, about 1.21%, about 1.22%, about 1.23%, about 1.24%, about 1.25%, about 1.26%, about 1.27%, about 1.28%, about 1.29%, about 1.30%, about 1.31%, about 1.32%, about 1.33%, about 1.34%, about 1.35%, about 1.36%, about 1.37%, about 1.38%, about 1.39%, or about 1.40%. As used herein, the percentage is calculated as (weight of surfactant)/(weight of DAS+weight of styrene)*100.

In some embodiments, the surfactant is sodium lauryl sulfate (i.e., sodium dodecyl sulfate).

In some embodiments, the ratio of sodium lauryl sulfate to total monomer, expressed as a percentage, is between about 0.2% to about 6.0%, such as, for example, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, or about 6.0%.

In some embodiments, the ratio of sodium lauryl sulfate to total monomer, expressed as a percentage, is between about 0.8% to about 3.0%, such as, for example, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0%. In some embodiments, the ratio of sodium lauryl sulfate to total monomer, expressed as a percentage, is between about 1.2% to about 1.4%, such as, for example, about 1.20%, about 1.21%, about 1.22%, about 1.23%, about 1.24%, about 1.25%, about 1.26%, about 1.27%, about 1.28%, about 1.29%, about 1.30%, about 1.31%, about 1.32%, about 1.33%, about 1.34%, about 1.35%, about 1.36%, about 1.37%, about 1.38%, about 1.39%, or about 1.40%. As used herein, the percentage is calculated as (weight of SLS)/(weight of DAS+weight of styrene)*100.

In other embodiments, the surfactant is cetyl alcohol.

In some embodiments, the ratio of cetyl alcohol to total monomer, expressed as a percentage, is between about 0.5% to about 10.0%, such as, for example, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, about 6.0%, about 6.1%, about 6.2%, about 6.3%, about 6.4%, about 6.5%, about 6.6%, about 6.7%, about 6.8%, about 6.9%, about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, or about 10.0%.

In some embodiments, the ratio of cetyl alcohol to total monomer, expressed as a percentage, is between about 2.0% to about 7.0%, such as, for example, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, about 6.0%, about 6.1%, about 6.2%, about 6.3%, about 6.4%, about 6.5%, about 6.6%, about 6.7%, about 6.8%, about 6.9%, or about 7.0%. In other embodiments, the ratio of cetyl alcohol to total monomer, expressed as a percentage, is between about 2.50% to about 3.40%, such as, for example, 2.50%, 2.51%, 2.52%, 2.53%, 2.54%, 2.55%, 2.56%, 2.57%, 2.58%, 2.59%, 2.60%, 2.61%, 2.62%, 2.63%, 2.64%, 2.65%, 2.66%, 2.67%, 2.68%, 2.69%, 2.70%, 2.71%, 2.72%, 2.73%, 2.74%, 2.75%, 2.76%, 2.77%, 2.78%, 2.79%, 2.80%, 2.81%, 2.82%, 2.83%, 2.84%, 2.85%, 2.86%, 2.87%, 2.88%, 2.89%, 2.90%, 2.91%, 2.92%, 2.93%, 2.94%, 2.95%, 2.96%, 2.97%, 2.98%, 2.99%, 3.00%, 3.01%, 3.02%, 3.03%, 3.04%, 3.05%, 3.06%, 3.07%, 3.08%, 3.09%, 3.10%, 3.11%, 3.12%, 3.13%, 3.14%, 3.15%, 3.16%, 3.17%, 3.18%, 3.19%, 3.20%, 3.21%, 3.22%, 3.23%, 3.24%, 3.25%, 3.26%, 3.27%, 3.28%, 3.29%, 3.30%, 3.31%, 3.32%, 3.33%, 3.34%, 3.35%, 3.36%, 3.37%, 3.38%, 3.39%, or 3.40%. As used herein, the percentage is calculated as (weight of cetyl alcohol)/(weight of DAS+weight of styrene)*100.

In yet other embodiments, the surfactant is a mixture of sodium lauryl sulfate and cetyl alcohol. In some embodiments, the weight ratio of cetyl alcohol to sodium lauryl sulfate is between about 2.0 and about 4.0, such as, for example, about 2.0, about 2.1, about 2.2, about 2.3, about 2.4, about 2.5, about 2.6, about 2.7, about 2.8, about 2.9, about 3.0, about 3.1, about 3.2, about 3.3, about 3.4, about 3.5, about 3.6, about 3.7, about 3.8, about 3.9, or about 4.0.

In other embodiments, the weight ratio of cetyl alcohol to sodium lauryl sulfate is between about 2.30 and about 2.80, such as, for example, about 2.30, about 2.31, about 2.32, about 2.33, about 2.34, about 2.35, about 2.36, about 2.37, about 2.38, about 2.39, about 2.40, about 2.41, about 2.42, about 2.43, about 2.44, about 2.45, about 2.46, about 2.47, about 2.48, about 2.49, about 2.50, about 2.51, about 2.52, about 2.53, about 2.54, about 2.55, about 2.56, about 2.57, about 2.58, about 2.59, about 2.60, about 2.61, about 2.62, about 2.63, about 2.64, about 2.65, about 2.66, about 2.67, about 2.68, about 2.69, about 2.70, about 2.71, about 2.72, about 2.73, about 2.74, about 2.75, about 2.76, about 2.77, about 2.78, about 2.79, or about 2.80.

In some aspects of the emulsion polymerization, the polymerization mixture includes an initiator, such as, for example, a persulfate (e.g., sodium persulfate, potassium persulfate, ammonium persulfate, other persulfates), benzoyl peroxide, t-butyl hydroperoxide, and other water-soluble free radical initiators.

In some embodiments, the ratio of initiator to total monomer, expressed as a percentage, is between about 0.1% to about 3.0%, such as, for example, about 0.1%, about 0.2%, about 0.3%, about 0.4%, about 0.5%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0%. As used herein, the percentage is calculated as (weight of initiator)/(weight of DAS+weight of styrene)*100.

In some embodiments, the ratio of initiator to total monomer, expressed as a percentage, is between about 1.0% to about 3.0%, such as, for example, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0%. As used herein, the percentage is calculated as (weight of initiator)/(weight of DAS+weight of styrene)*100.

In some embodiments, the ratio of initiator to total monomer, expressed as a percentage, is between about 1.2% to about 1.4%, such as, for example, about 1.20%, about 1.21%, about 1.22%, about 1.23%, about 1.24%, about 1.25%, about 1.26%, about 1.27%, about 1.28%, about 1.29%, about 1.30%, about 1.31%, about 1.32%, about 1.33%, about 1.34%, about 1.35%, about 1.36%, about 1.37%, about 1.38%, about 1.39%, or about 1.40%. As used herein, the percentage is calculated as (weight of initiator)/(weight of DAS+weight of styrene)*100.

In some embodiments, the initiator is a water-soluble free radical initiator.

In some embodiments, the initiator is potassium persulfate.

In some embodiments, the initiator is sodium persulfate.

In some embodiments, the initiator is ammonium persulfate.

In some embodiments, the initiator is benzoyl peroxide.

In some embodiments, the initiator is t-butyl hydroperoxide.

In some embodiments, the ratio of potassium persulfate to total monomer, expressed as a percentage, is between about 0.1% to about 3.0%, such as, for example, about 0.1%, about 0.2%, about 0.3%, about 0.4%, about 0.5%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0%. As used herein, the percentage is calculated as (weight of potassium persulfate)/(weight of DAS+weight of styrene)*100.

In some embodiments, the ratio of potassium persulfate to total monomer, expressed as a percentage, is between about 1.0% to about 3.0%, such as, for example, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0%. As used herein, the percentage is calculated as (weight of potassium persulfate)/(weight of DAS+weight of styrene)*100.

In some embodiments, the ratio of potassium persulfate to total monomer, expressed as a percentage, is between about 1.2% to about 1.4%, such as, for example, about 1.20%, about 1.21%, about 1.22%, about 1.23%, about 1.24%, about 1.25%, about 1.26%, about 1.27%, about 1.28%, about 1.29%, about 1.30%, about 1.31%, about 1.32%, about 1.33%, about 1.34%, about 1.35%, about 1.36%, about 1.37%, about 1.38%, about 1.39%, or about 1.40%. As used herein, the percentage is calculated as (weight of potassium persulfate)/(weight of DAS+weight of styrene)*100.

In some aspects of the emulsion polymerization, the polymerization mixture includes a chain transfer agent, such as, for example, dodecyl thiol (also known as dodecyl mercaptan or n-dodecanethiol), carbon tetrachloride, or halocarbons. The amount of chain transfer agent used will vary the molecular weight of the polymer.

In some embodiments, the ratio of chain transfer agent to total monomer, expressed as a percentage, is between about 0.05% to about 10%, such as, for example, about 0.05%, about 0.06%, about 0.07%, about 0.08%, about 0.09%, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, about 0.26%, about 0.27%, about 0.28%, about 0.29%, about 0.30%, about 0.31%, about 0.32%, about 0.33%, about 0.34%, about 0.35%, about 0.36%, about 0.37%, about 0.38%, about 0.39%, about 0.40%, about 0.41%, about 0.42%, about 0.43%, about 0.4%, about 0.45%, about 0.46%, about 0.47%, about 0.48%, about 0.49%, about 0.50%, about 0.51%, about 0.52%, about 0.53%, about 0.54%, about 0.55%, about 0.56%, about 0.57%, about 0.58%, about 0.59%, about 0.60%, about 0.61%, about 0.62%, about 0.63%, about 0.64%, about 0.65%, about 0.66%, about 0.67%, about 0.68%, about 0.69%, about 0.70%, about 0.71%, about 0.72%, about 0.73%, about 0.74%, about 0.75%, about 0.76%, about 0.77%, about 0.78%, about 0.79%, about 0.80%, about 0.81%, about 0.82%, about 0.83%, about 0.84%, about 0.85%, about 0.86%, about 0.87%, about 0.88%, about 0.89%, about 0.90%, about 0.91%, about 0.92%, about 0.93%, about 0.94%, about 0.95%, about 0.96%, about 0.97%, about 0.98%, about 0.99%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, about 6.0%, about 6.1%, about 6.2%, about 6.3%, about 6.4%, about 6.5%, about 6.6%, about 6.7%, about 6.8%, about 6.9%, about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, or about 10.0%. As used herein, the percentage is calculated as (weight of chain transfer agent)/(weight of DAS+weight of styrene)*100.

In some embodiments, the ratio of chain transfer agent to total monomer, expressed as a percentage, is between about 0.1% to about 0.8%, such as, for example, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, about 0.26%, about 0.27%, about 0.28%, about 0.29%, about 0.30%, about 0.31%, about 0.32%, about 0.33%, about 0.34%, about 0.35%, about 0.36%, about 0.37%, about 0.38%, about 0.39%, about 0.40%, about 0.41%, about 0.42%, about 0.43%, about 0.4%, about 0.45%, about 0.46%, about 0.47%, about 0.48%, about 0.49%, about 0.50%, about 0.51%, about 0.52%, about 0.53%, about 0.54%, about 0.55%, about 0.56%, about 0.57%, about 0.58%, about 0.59%, about 0.60%, about 0.61%, about 0.62%, about 0.63%, about 0.64%, about 0.65%, about 0.66%, about 0.67%, about 0.68%, about 0.69%, about 0.70%, about 0.71%, about 0.72%, about 0.73%, about 0.74%, about 0.75%, about 0.76%, about 0.77%, about 0.78%, about 0.79%, about 0.80%, about 0.81%, about 0.82%, about 0.83%, about 0.84%, about 0.85%, about 0.86%, about 0.87%, about 0.88%, about 0.89%, or about 0.90%. As used herein, the percentage is calculated as (weight of chain transfer agent)/(weight of DAS+weight of styrene)*100.

In some embodiments, the chain transfer agent is dodecyl thiol.

In some embodiments, the chain transfer agent is carbon tetrachloride.

In some embodiments, the chain transfer agent is halocarbons.

In some embodiments, the ratio of dodecyl thiol to total monomer, expressed as a percentage, is between about 0.05% to about 10%, such as, for example, about 0.05%, about 0.06%, about 0.07%, about 0.08%, about 0.09%, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, about 0.26%, about 0.27%, about 0.28%, about 0.29%, about 0.30%, about 0.31%, about 0.32%, about 0.33%, about 0.34%, about 0.35%, about 0.36%, about 0.37%, about 0.38%, about 0.39%, about 0.40%, about 0.41%, about 0.42%, about 0.43%, about 0.4%, about 0.45%, about 0.46%, about 0.47%, about 0.48%, about 0.49%, about 0.50%, about 0.51%, about 0.52%, about 0.53%, about 0.54%, about 0.55%, about 0.56%, about 0.57%, about 0.58%, about 0.59%, about 0.60%, about 0.61%, about 0.62%, about 0.63%, about 0.64%, about 0.65%, about 0.66%, about 0.67%, about 0.68%, about 0.69%, about 0.70%, about 0.71%, about 0.72%, about 0.73%, about 0.74%, about 0.75%, about 0.76%, about 0.77%, about 0.78%, about 0.79%, about 0.80%, about 0.81%, about 0.82%, about 0.83%, about 0.84%, about 0.85%, about 0.86%, about 0.87%, about 0.88%, about 0.89%, about 0.90%, about 0.91%, about 0.92%, about 0.93%, about 0.94%, about 0.95%, about 0.96%, about 0.97%, about 0.98%, about 0.99%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, about 6.0%, about 6.1%, about 6.2%, about 6.3%, about 6.4%, about 6.5%, about 6.6%, about 6.7%, about 6.8%, about 6.9%, about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, or about 10.0%. As used herein, the percentage is calculated as (weight of dodecyl thiol)/(weight of DAS+weight of styrene)*100.

In some embodiments, the ratio of dodecyl thiol to total monomer, expressed as a percentage, is between about 0.1% to about 0.8%, such as, for example, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, about 0.26%, about 0.27%, about 0.28%, about 0.29%, about 0.30%, about 0.31%, about 0.32%, about 0.33%, about 0.34%, about 0.35%, about 0.36%, about 0.37%, about 0.38%, about 0.39%, about 0.40%, about 0.41%, about 0.42%, about 0.43%, about 0.4%, about 0.45%, about 0.46%, about 0.47%, about 0.48%, about 0.49%, about 0.50%, about 0.51%, about 0.52%, about 0.53%, about 0.54%, about 0.55%, about 0.56%, about 0.57%, about 0.58%, about 0.59%, about 0.60%, about 0.61%, about 0.62%, about 0.63%, about 0.64%, about 0.65%, about 0.66%, about 0.67%, about 0.68%, about 0.69%, about 0.70%, about 0.71%, about 0.72%, about 0.73%, about 0.74%, about 0.75%, about 0.76%, about 0.77%, about 0.78%, about 0.79%, about 0.80%, about 0.81%, about 0.82%, about 0.83%, about 0.84%, about 0.85%, about 0.86%, about 0.87%, about 0.88%, about 0.89%, or about 0.90%. As used herein, the percentage is calculated as (weight of dodecyl thiol)/(weight of DAS+weight of styrene)*100.

In some embodiments, the polymerization reaction also comprises a buffer, such as, for example, sodium bicarbonate.

In some embodiments, the polymerization reaction is an emulsion polymerization. Accordingly, the solvent for the emulsion polymerization comprises an aqueous solvent, such as water. The emulsion is formed using a surfactant and optionally salt. An initiator, such as potassium persulfate starts the polymerization reaction. In some embodiments, the reaction is performed at an elevated temperature, such as between 65° C. and the boiling point of the solvents.

In some embodiments, 3,4-diacetoxystyrene (DAS) is co-polymerized with styrene via emulsion polymerization. Styrene and 3,4-diacetoxystyrene (DAS) are blended together in the desired ratio with a chain transfer agent to give a monomer blend. In some embodiments, varying the amount of chain transfer agent can control the molecular weight of the polymer.

The monomer blend is then added to a stirred aqueous solution of surfactant(s), chain initiator, and buffer at elevated temperature in an inert atmosphere to give the emulsion polymerization reaction mixture.

In some aspects, the amount of water used in the emulsion polymerization as a function of the total monomer used in the reaction is about 190-about 320 grams of total monomer per liter of water, such as, for example, about 190, 195, 200, 205, 210, 215, 220, 225, 230, 235, 240, 245, 250, 255, 260, 265, 270, 275, 280, 285, 290, 295, 300, 305, 310, 315, or 320 grams of total monomer per liter of water.

In some embodiments, the elevated temperature is a temperature from about 40° C. to about 100° C., such as for example, about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., or about 100° C. In some embodiments, the elevated temperature is about 70° C.

In some embodiments, the inert atmosphere for the emulsion polymerization reaction mixture is argon. In other embodiments, the inert atmosphere is nitrogen.

In some embodiments, the emulsion polymerization reaction mixture is stirred at elevated temperature for a period of time of about 3-8 hrs., such as, for example, about 3 hrs., about 3.5 hrs., about 4 hrs., about 4.5 hrs., about 5 hrs., about 5.5 hrs., about 6 hrs., about 6.5 hrs., about 7 hrs., about 7.5 hrs., or about 8 hrs. In some embodiments, the emulsion polymerization reaction mixture is stirred at elevated temperature for about 4 hours. In other embodiments, the emulsion polymerization reaction mixture is stirred at elevated temperature for about 6 hours.

In some embodiments, 3,4-diacetoxystyrene (DAS) is co-polymerized with styrene via an emulsion polymerization. In such embodiments, styrene and 3,4-diacetoxystyrene (DAS) are blended together in the desired ratio with a chain transfer agent such as n-dodecanethiol to give a monomer blend. Varying the amount of chain transfer agent can manipulate and control the molecular weight of the polymer. This monomer blend is added to a stirring aqueous solution of sodium lauryl sulfate, cetyl alcohol, potassium persulfate, and sodium bicarbonate at 65° C. under argon to give an emulsion polymerization reaction mixture. After four hours, the emulsion polymerization reaction mixture is cooled to room temperature, precipitated into a brine solution and filtered to provide the protected polymer poly(3,4-diacetoxystyrene-co-styrene).

In other embodiments, 3,4-diacetoxystyrene (DAS) is co-polymerized with styrene via an emulsion polymerization in which styrene and 3,4-diacetoxystyrene (DAS) are blended together in the desired ratio with a chain transfer agent such as n-dodecanethiol to give a monomer blend. Varying the amount of chain transfer agent can manipulate and control the molecular weight of the polymer. This monomer blend is added to a stirring aqueous solution of sodium lauryl sulfate, cetyl alcohol, potassium persulfate, and sodium bicarbonate at 70° C. under nitrogen to give an emulsion polymerization reaction mixture. After six hours, the emulsion polymerization reaction mixture is cooled and the precipitated protected polymer poly(3,4-diacetoxystyrene-co-styrene) is collected by centrifugation.

In some embodiments, the polymerization is an anionic polymerization. The polymerization is performed in an organic solvent. DAS and styrene are blended together and dissolved in a solvent, such as tetrahydrofuran or cyclohexane. Under an inert atmosphere, such as nitrogen or argon, a radical initiator, such as sec-butyl lithium or n-butyllithium, is added to the polymerization solution. The reaction solution is maintained under constant stirring at temperatures between −78° C. and 25° C.

In some embodiments, following the polymerization reaction, the poly(3,4-diacetoxystyrene-co-styrene) polymer is isolated from the polymerization reaction mixture.

In some embodiments, the poly(3,4-diacetoxystyrene-co-styrene) polymer is isolated from the polymerization reaction mixture by precipitation and filtration.

In some embodiments, the poly(3,4-diacetoxystyrene-co-styrene) polymer may be precipitated by cooling the polymerization reaction mixture.

In other embodiments, the poly(3,4-diacetoxystyrene-co-styrene) polymer may be precipitated by mixing the polymerization reaction mixture with a salt solution.

In still other embodiments, the poly(3,4-diacetoxystyrene-co-styrene) polymer may be precipitated by cooling the polymerization reaction mixture and mixing with a salt solution. The precipitated polymer is then filtered and washed with a solvent such as water.

In other embodiments, an acid such as HCl is added to the emulsion to break the emulsion, which results in precipitation of the poly(3,4-diacetoxystyrene-co-styrene), which is then isolated by filtration. Such embodiments are advantageous because they require less water to precipitate the poly(3,4-diacetoxystyrene-co-styrene). Moreover, the acid added to break the emulsion does not deprotect the poly(3,4-diacetoxystyrene-co-styrene).

In still other embodiments, the poly(3,4-diacetoxystyrene-co-styrene) polymer may be precipitated by cooling the polymerization reaction mixture and then transferring the mixture to a centrifuge where the water is removed to yield protected polymer powder.

In some aspects, the poly(3,4-diacetoxystyrene-co-styrene) polymer produced by the processes of the disclosure has a molecular weight in the range of about 25,000 to about 1,100,000. In some aspects, the poly(3,4-diacetoxystyrene-co-styrene) polymer produced by the processes of the disclosure has a molecular weight in the range of about 25,000 to about 300,000, such as, for example, 25,000, 50,000, 75,000, 100,000, 125,000, 150,000, 175,000, 200,000, 225,000, 250,000, 275,000, or 300,000.

In some aspects, the poly(3,4-diacetoxystyrene-co-styrene) polymer produced by the processes of the disclosure has a polydisperity index (PDI) of about 2 to about 30, such as, for example, about 2, 3, 4, 5, 6, 7, 8, 9, 10, 11, 12, 13, 14, 15, 16, 17, 18, 19, 20, 21, 22, 23, 24, 25, 26, 27, 28, 29, or 30. As used herein, the term polydisperity index refers to the ratio of the weight average molecular weight to the number average molecular weight. In some aspects, the poly(3,4-diacetoxystyrene-co-styrene) polymer produced by the processes of the disclosure has a polydisperity index (PDI) of about 2 to about 4, such as, for example, about 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.

In some aspects, the emulsion polymerization reaction results in at least 95% of the monomer (DAS and styrene) being converted to polymer, such as, for example, at least 95%, at least 96%, at least 97%, at least 98%, at least 99%, at least 99.5%, or at least 99.8% of the monomer (DAS and styrene) being converted to polymer. The extent of polymer conversion may be determined by methods known to those of skill in the art, including, for example, NMR, FTIR, or liquid chromatography.

### Deprotection

In some aspects of the processes of the disclosure, the poly(3,4-diacetoxystyrene-co-styrene) polymer is deprotected to give poly(catechol-styrene) (PCS), as illustrated in Scheme 2, below. This deprotection is achieved by subjecting the poly(3,4-diacetoxystyrene-co-styrene) polymer to conditions that cleave the acetate esters. Such conditions include, for example, treatment with aqueous acids, such as, for example, hydrochloric acid (HCl), p-toluene sulfonic acid (p-TsOH), fluoroboric acid (HBF₄), and camphorsulfonic acid (CSA), or treatment with aqueous bases, such as, for example NaOH, KOH, NH₃, and methylamine (CH₃NH₂).

### Scheme 2:

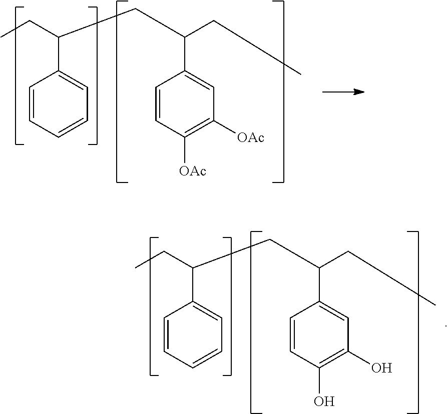

In some aspects of the processes of the disclosure, the poly(3,4-diacetoxystyrene-co-styrene) polymer is deprotected using acid to give poly(catechol-styrene) (PCS), as shown in Scheme 3.

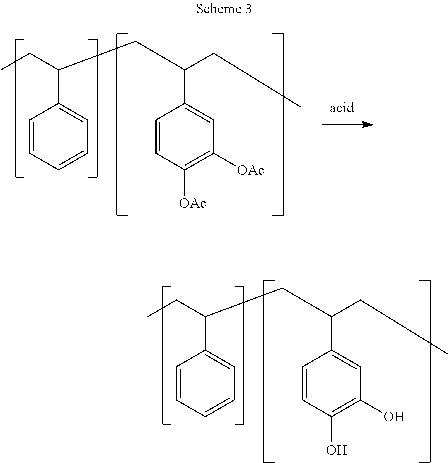

In some embodiments, deprotection reaction is performed by treating the poly(3,4-diacetoxystyrene-co-styrene) polymer with acid. In some embodiments, the acid is selected from hydrochloric acid (HCl), p-toluene sulfonic acid (p-TsOH), fluoroboric acid (HBF₄), camphorsulfonic acid (CSA) and nitric acid, and combinations thereof. In some embodiments, the acid is HCl.

In some embodiments, the deprotection reaction is performed by treating the poly(3,4-diacetoxystyrene-co-styrene) polymer with acid in an amount of 0.9 to 1.9 mmol of acid per gram of poly(3,4-diacetoxystyrene-co-styrene) polymer, such as, for example, 0.9, 0.91, 0.92, 0.93, 0.94, 0.95, 0.96, 0.97, 0.98, 0.99, 1.0, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.31, 1.32, 1.33, 1.34, 1.35, 1.36, 1.37, 1.38, 1.39, 1.4, 1.41, 1.42, 1.43, 1.44, 1.45, 1.46, 1.47, 1.48, 1.49, 1.5, 1.51, 1.52, 1.53, 1.54, 1.55, 1.56, 1.57, 1.58, 1.59, 1.6, 1.61, 1.62, 1.63, 1.64, 1.65, 1.66, 1.67, 1.68, 1.69, 1.7, 1.71, 1.72, 1.73, 1.74, 1.75, 1.76, 1.77, 1.78, 1.79, 1.8, 1.81, 1.82, 1.83, 1.84, 1.85, 1.86, 1.87, 1.88, 1.89, or 1.9 mmol of acid per gram of poly(3,4-diacetoxystyrene-co-styrene) polymer.

In some embodiments, the deprotection reaction is performed by treating the poly(3,4-diacetoxystyrene-co-styrene) polymer with acid in an amount of 1.4 to 1.5 mmol of acid per gram of poly(3,4-diacetoxystyrene-co-styrene) polymer, such as, for example, 1.4, 1.41, 1.42, 1.43, 1.44, 1.45, 1.46, 1.47, 1.48, 1.49, or 1.5 mmol of acid per gram of poly(3,4-diacetoxystyrene-co-styrene) polymer.

In some embodiments, the acid is added to the deprotection reaction as a 1M-8M solution, such as, for example, a 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8 M acid solution.

In some embodiments, the acid is added to the deprotection reaction as 4M-8M solution, such as, for example, a 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8 M acid solution.

In some embodiments, the deprotection reaction is performed by treating the poly(3,4-diacetoxystyrene-co-styrene) polymer with hydrochloric acid (HCl). In some embodiments, the HCl is added to the deprotection reaction as 1M-8M solution, such as, for example, a 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8 M acid solution.

In other embodiments, the HCl is added to the deprotection reaction as 4M-8M solution, such as, for example, a 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8 M HCl solution.

In some embodiments, the deprotection reaction is performed by treating the poly(3,4-diacetoxystyrene-co-styrene) polymer with 6M HCl.

In some aspects of the deprotection reaction, the poly(3,4-diacetoxystyrene-co-styrene) polymer is dissolved in a solvent, such as, for example, THF, acetone, or dimethylformamide (DMF). In some embodiments of the deprotection reaction, the solvent is THF. In some embodiments of the deprotection reaction, the solvent is acetone. In other embodiments of the deprotection reaction, the solvent is dimethylformamide (DMF).

In some aspects of the deprotection reaction, the poly(3,4-diacetoxystyrene-co-styrene) polymer is dissolved in the solvent at a concentration of 280-500 grams of poly(3,4-diacetoxystyrene-co-styrene) polymer per liter of solvent.

In some embodiments of the deprotection reaction, the poly(3,4-diacetoxystyrene-co-styrene) polymer is dissolved in a solvent at a concentration of 280-345 grams of poly(3,4-diacetoxystyrene-co-styrene) polymer per liter of solvent, such as, for example, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, or 345 grams of poly(3,4-diacetoxystyrene-co-styrene) polymer per liter of solvent.

In some aspects of the deprotection reaction, the reaction mixture is heated to an elevated temperature, such as, for example, a temperature from about 40° C. to about 100° C., such as for example, about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., about 80° C., about 81° C., about 82° C., about 83° C., about 84° C., about 85° C., about 86° C., about 87° C., about 88° C., about 89° C., about 90° C., about 91° C., about 92° C., about 93° C., about 94° C., about 95° C., about 96° C., about 97° C., about 98° C., about 99° C., or about 100° C.

In some embodiments of the deprotection reaction, the reaction mixture is heated to about 70° C.

In other embodiments of the deprotection reaction, the reaction mixture is heated to the reflux temperature of the solvent.

In some aspects, the deprotection reaction is allowed to proceed for up to 48 hours, such as, for example, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 31 hours, 32 hours, 33 hours, 34 hours, 35 hours, 36 hours, 37 hours, 38 hours, 39 hours, 40 hours, 41 hours, 42 hours, 43 hours, 44 hours, 45 hours, 46 hours, 47 hours, or 48 hours. In some embodiments, the deprotection reaction is allowed to proceed for 24 hours. In some embodiments, the deprotection reaction is allowed to proceed for 48 hours.

In some embodiments, after deprotection, the reaction mixture is neutralized with a base, such as sodium bicarbonate.

In some aspects of the disclosure, the deprotection reaction results in at least 90% deprotection, such as for example, at least 90% deprotection, at least 91% deprotection, at least 92% deprotection, at least 93% deprotection, at least 94% deprotection, at least 95% deprotection, at least 96% deprotection, at least 97% deprotection, at least 98% deprotection, at least 99% deprotection, or 100% deprotection. As used here, % deprotection refers to the % of acetoxy-protected catechol hydroxyl groups that have been converted to catechol hydroxyl groups (i.e., deprotected catechol hydroxyl groups) in the PCS polymer. % deprotection can be measured by standard techniques, such as, for example, by NMR.

In some embodiments, the deprotection reaction results in at least 95% deprotection.

In some embodiments, the deprotected product, poly(catechol-styrene) polymer, is isolated by precipitation and filtration. For example, in some embodiments, the poly(catechol-styrene) polymer is precipitated by cooling the deprotection reaction mixture to about 25-35° C. and then adding a solvent (i.e., an anti-solvent) such as water to the reaction mixture. In other embodiments, the poly(catechol-styrene) polymer is precipitated by cooling the deprotection reaction mixture to about 25-35° C. and then adding the reaction mixture into an antisolvent such as water.

In some embodiments, the poly(catechol-styrene) polymer is precipitated by cooling the deprotection reaction mixture to about 25-35° C. and then adding the reaction mixture into water. In some embodiments, the poly(catechol-styrene) polymer is precipitated by cooling the deprotection reaction mixture to about 25-35° C. and then adding the reaction mixture into deionized water.

Following precipitation, the precipitate may then be collected by filtration.

In some embodiments, the poly(catechol-styrene) polymer precipitate is re-dissolved in a solvent, such as a polar solvent. Examples of polar solvents include acetone, dichloromethane, methyl ethyl ketone, and DMF. The poly(catechol-styrene) polymer may then be precipitated by the addition of a non-polar solvent, such as hexane or ether. In some embodiments, the poly(catechol-styrene) polymer may be re-dissolved a third time and isolated by removing the solvent by evaporation.

In other embodiments, the poly(catechol-styrene) polymer precipitate is dissolved in a solvent such as, for example, acetone or THF. The resulting solution is then added portionwise into water to precipitate the poly(catechol-styrene) polymer. This procedure—dissolving into solvent and then adding the resulting solution to portionwise into water—can be repeated any number of times.

In other embodiments, the poly(catechol-styrene) polymer precipitate is dissolved in a solvent such as, for example, acetone or THF. The resulting solution is then added portionwise into an antisolvent, such as hexanes, to precipitate the poly(catechol-styrene) polymer. This procedure—dissolving into solvent and then adding the resulting solution portionwise into antisolvent—can be repeated any number of times.

In some embodiments, the solvents are removed by evaporation and the poly(catechol-styrene) polymer is dissolved in a polar solvent, such as acetone. The acetone solution may be evaporated to provide the solid poly(catechol-styrene) polymer or may be spray dried to provide the solid poly(catechol-styrene) polymer.

The deprotection and isolation steps may be challenging as the sticky, partially solvated, precipitated poly(catechol-styrene) polymer is difficult to work with and can pose challenges to automated production, thus currently relies on significant manual effort.

In some embodiments, the protected polymer, poly(3,4-diacetoxystyrene-co-styrene), is dissolved in tetrahydrofuran (THF) at 45° C. Upon complete dissolution, six molar hydrochloric acid (HCl) is added, and the reaction is refluxed overnight at 70° C. The next day, the reaction is cooled to room temperature and precipitated into stirring water. The water is decanted off and the polymer is taken up into acetone and portion-wise precipitated into stirring hexanes. The hexanes are decanted off and the polymer collected and dried via vacuum oven.

In other embodiments, deprotection is performed by treating the poly(3,4-diacetoxystyrene-co-styrene) polymer with base, such as potassium hydroxide. The reaction mixture is neutralized, and the product is isolated by precipitation and re-dissolving as described previously.

In some embodiments, the polymerization and deprotection synthetic steps are conducted in the same reaction vessel without isolation of the intermediate protected polymer. The resulting poly(catechol-styrene) polymer may be emulsified and could be spray dried or solidified, such as by the addition of salt. The solidified poly(catechol-styrene) polymer may be purified by washing with a solvent such as water.

In some embodiments, poly(catechol-styrene) produced through this process have molecular weights ranging from 15,000 to 1,000,000, such as 15,000 to 188,000 as measured by GPC.

In other embodiments, the poly(catechol-styrene) produced by the processes of the disclosure have a molecular weight of about 50,000 to about 400,000, such as, for example, about 50,000, 75,000, 100,000, 125,000, 150,000, 175,000, 200,000, 225,000, 250,000, 275,000, 300,000, 325,000, 350,000, 375,000, or 400,000.

Aluminum lap shears and an Instron were used to conduct pull-tests. The average strengths of the different molecular weight PCS were compared to the average strength of the PCS produced from dimethoxyacetophenone monomers, which showed optimum performance at 80,000 molecular weight. The average strengths of the different 80,000 molecular weight PCS did not show significant difference, despite different process methods. Additionally, peak strength was observed with PCS produced by this process at a molecular weight of 122,000. This was surprising because the literature shows that PCS strength increases up to the 80,000-100,000 range, and then starts declining.

In some embodiments, the poly(catechol-styrene) polymer has a polydispersity index (PDI) of about 1-about 4 as measured by GPC, such as, for example, about 1, about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, or about 4.

In other embodiments, the poly(catechol-styrene) polymer has a polydispersity index (PDI) of about 2 to about 4, as measured by GPC, such as, for example, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, or about 4.

In yet other embodiments, the poly(catechol-styrene) polymer has a polydispersity index (PDI) of about 2 to about 4, as measured by GPC, such as, for example, about 2, about 2.1, about 2.2, about 2.3, about 2.4, about 2.5, about 2.6, about 2.7, about 2.8, about 2.9, or about 3.

The emulsion polymerization processes described herein are advantageous processes because they result in extremely high monomer conversion, often 99%+. As a result of this high degree of monomer conversion, the amount of unreacted monomer to be removed from the product is minimized. Removal of unreacted monomer is made difficult by the heat and air sensitivity of the product polymer.

As discussed above, the PCS production processes of the disclosure comprise a polymerization reaction, and a deprotection reaction. In some embodiments, the polymerization reaction and the deprotection reaction are done is separate reaction vessels. In other embodiments, the polymerization reaction and the deprotection reaction are done in the same reaction vessel, i.e., in a “one pot” process.

Different applications of the PCS polymer may require different catechol contents. By adjusting the reaction conditions of the processes described herein, the catechol content of the resulting PCS polymer can be controlled. For example, the catechol content may be controlled by adjusting the weight ratio of styrene monomer to DAS monomer used in the emulsion polymerization reaction, by adjusting the amount of surfactant in the emulsion polymerization reaction, by adjusting amount of initiator used in the emulsion polymerization reaction, or by adjusting the amount of chain transfer agent used in the emulsion polymerization reaction. In some embodiments, the catechol content of the PCS polymer produced by the disclosed processes ranges from about 10% to about 75% by weight, such as, for example, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, or about 75% by weight.

In some embodiments, the catechol content of the PCS polymer produced by the disclosed processes is about 75% by weight.

In some aspects, the disclosure is directed to a polymerization reaction end-product comprising poly(3,4-diacetoxystyrene-co-styrene) polymer, wherein the unconverted monomer present in the reaction end product is less than 5% of the monomer that was added to the reaction mixture, such as, for example, less than 5%, less than 4%, less than 3%, less than 2%, less than 1%, less than 0.5%, or less than 0.1%. In some embodiments, the unconverted monomer present in the reaction mixture is less than 1% of the monomer that was added to the reaction mixture.

In some aspects, the disclosure is directed to a polymerization reaction end-product comprising PCS polymer, wherein the unconverted monomer present in the reaction end product is less than 5% of the monomer that was added to the reaction mixture, such as, for example, less than 5%, less than 4%, less than 3%, less than 2%, less than 1%, less than 0.5%, or less than 0.1%. In some embodiments, the unconverted monomer present in the reaction mixture is less than 1% of the monomer that was added to the reaction mixture.

The PCS processes of the disclosure have several distinct advantages relative to PCS processes that use methoxy catechol protecting groups. First, from an economic perspective, PCS processes that use methoxy catechol protecting groups require expensive deprotection reagents which make those processes economically burdensome. In contrast, the processes of the disclosure, which use acetate protecting groups, require much less expensive deprotection reagents. Second, processes that use methoxy catechol protecting groups require much higher temperatures (165° C.) to accomplish the deprotection. As a result, a high boiling point solvent, such as DMF, is needed for the deprotection reaction. This higher boiling point solvent becomes difficult to completely remove in the drying step, and thus can impair the suitability of the resulting PCS for particular uses or applications. For example, the FDA limits the amount of certain residual solvents for safety reasons, which could hinder the use of the PCS made from methoxy catechol protecting groups in biomedical applications. The use of certain high boiling solvents also rules out the potential use of spray drying applications for large scale PCS production. The processes of the disclosure avoid all of these problems.

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

The modifier “about” should be considered as disclosing the range defined by the absolute values of the two endpoints. For example, the expression “from about 2 to about 4” also discloses the range “from 2 to 4.” When used to modify a single number, the term “about” may refer to plus or minus 10% of the indicated number and includes the indicated number. For example, “about 10%” may indicate a range of 9% to 11%, and “about 1” means from 0.9 to 1.1.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

Where present, all ranges are inclusive and combinable. That is, references to values stated in ranges include every value within that range. For example, a range defined as from 400 to 450 ppm includes 400 ppm and 450 ppm as independent embodiments. Ranges of 400 to 450 ppm and 450 to 500 ppm may be combined to be a range of 400 to 500 ppm. Further, for the description of such range herein, where two or more than two particular values of a parameter are listed, this disclosure also includes a value selected from a range defined by any two of the two or more than two particular values of the said parameter, including the endpoints of such range.

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

The disclosure is also directed to the following aspects:
Aspect 1. A method of forming a poly(catechol-styrene) polymer comprising the steps of:
(i) polymerizing 3,4-diacetoxystyrene and styrene in an emulsion polymerization to form a poly(3,4-diacetoxystyrene-co-styrene) polymer, and
(ii) deprotecting the acetate groups of the resulting poly(3,4-diacetoxystyrene-co-styrene) polymer to form poly(catechol-styrene) polymer.
Aspect 2. The method of aspect 1, wherein after forming poly(3,4-diacetoxystyrene-co-styrene) polymer, it is precipitated.
Aspect 3. The method of aspect 2, wherein the precipitated poly(3,4-diacetoxystyrene-co-styrene) polymer is deprotected by dissolving in a solution and treating with acid.
Aspect 4. The method of aspect 1, wherein the polymerizing step further comprises a surfactant, initiator, and a chain transfer agent.
Aspect 5. The method of aspect 4, wherein the initiator comprises potassium persulfate.
Aspect 6. The method of aspect 4, wherein the chain transfer agent comprises dodecyl thiol.
Aspect 7. The method of aspect 1, wherein the polymerizing and deprotecting steps are conducted in one pot.
Aspect 8. The method of aspect 1, wherein after forming poly(catechol-styrene) polymer, it is precipitated.
Aspect 9. The method of aspect 8, wherein the precipitated poly(catechol-styrene) polymer is dissolved in a polar solvent, then precipitated from a non-polar solvent.
Aspect 10. The method of aspect 1, wherein the poly(3,4-diacetoxystyrene-co-styrene) polymer is deprotected by treating with acid.
Aspect 11. The method of aspect 10, wherein after treatment with acid, the mixture is neutralized with a base, concentrated to a solid, and poly(catechol-styrene) polymer is dissolved in a polar solvent.
12. The method of aspect 11, wherein the dissolved poly(catechol-styrene) polymer is spray dried.
Aspect 13. A poly(catechol-styrene) polymer formed by the process of aspect 1.
Aspect 14. The poly(catechol-styrene) polymer of aspect 13, wherein poly(catechol-styrene) polymer has a molecular weight of 15 k to 188 k as measured by GPC.
Aspect 15. The poly(catechol-styrene) polymer of aspect 13, wherein poly(catechol-styrene) polymer has a poly dispersity index (PDI) of 2-3 as measured by GPC.

### EXAMPLES

### Example 1—Production of Diacetoxy Protected Poly(catechol-styrene)

Styrene (300 milliliters) and diacetoxystyrene (200 grams) were blended together with n-dodecanethiol (5 milliliters) in an erlenmeyer flask equipped with a magnetic stir bar. The monomer blend was stirred with simultaneous argon bubbling throughout. An aqueous solution (1500 milliliters) of sodium lauryl sulfate (3.82 grams), cetyl alcohol (9.65 grams), potassium persulfate (10.63 grams), and sodium bicarbonate (0.001 grams) were prepared in a 3-neck round bottom flask equipped with an overhead stirrer. The emulsion solution was stirred and heated at 65° C. using a heating mantle for one hour. After which, argon was bubbled through for one hour. The emulsion was stirred at 200 rpm and the monomer blend was added. The stirring was increased to 530 rpm and the temperature was increased to 70° C. The polymerization was run overnight. The next day, the reaction was cooled to room temperature and was poured into a stirring, saturated solution of brine (15000 milliliters) in order to precipitate the polymer. The brine solution was stirred for one hour, after which stirring was stopped and the polymer was allowed to settle for one hour. The polymer was recovered via vacuum filtration and was carried forth into the deprotection not fully dry.

### Example 2—Production of Poly(catechol-styrene)

Diacetoxy protected poly(catechol-styrene) (233 grams) was added to a round bottom flask equipped with a magnetic stir bar and a reflux condenser. 1200 milliliters of tetrahydrofuran was added and the solution was stirred at 45° C., using a heating mantle, until complete dissolution of the polymer. Six molar hydrochloric acid (100 milliliters) was added. The temperature was raised to 70° C. and the reaction was heated for at least 16 hours. After which, the reaction was cooled to room temperature and was precipitated into stirring water (15000 milliliters). The polymer was stirred for one hour, after which stirring was stopped and the polymer was allowed to settle for an additional hour. The water as then decanted off and the polymer dissolved in acetone (1000 milliliters). The acetone-polymer solution was drop-wise precipitated into stirring hexanes (15000 milliliters). The polymer was stirred for one hour, after which stirring was stopped and the polymer was allowed to settle for an additional hour. The hexanes as decanted off and the polymer was collected and dried via vacuum oven. Yield: 145 grams (71%).

### Example 3—Polymer Molecular Weight

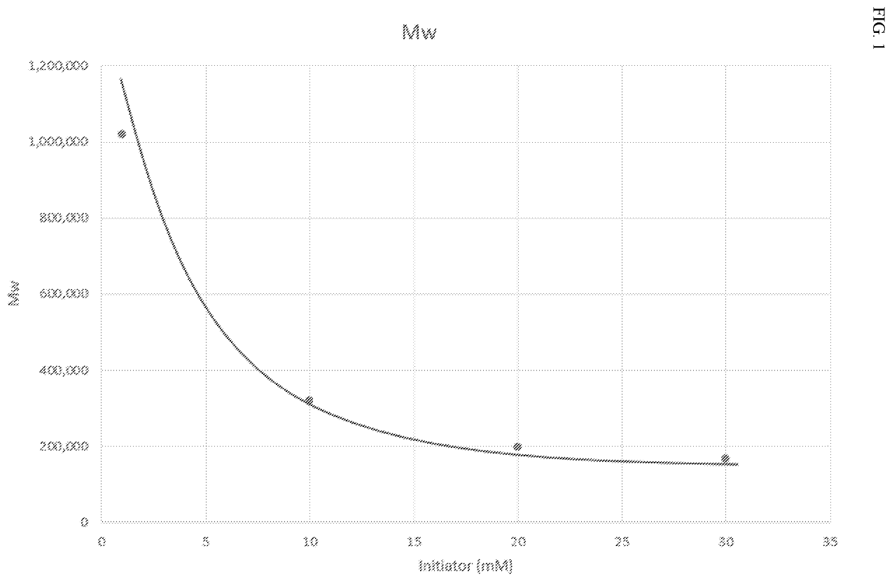

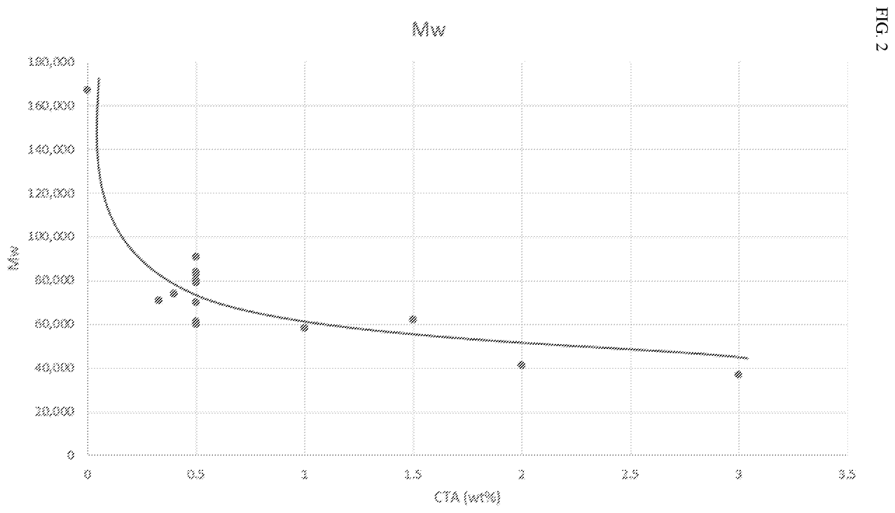

The amount of initiator and chain transfer agent (CTA) were varied to determine their effect on the polymer molecular weight. Results are shown in FIGS. 1 and 2.

### Example 4 (Comparative)—Polymerization Reactions

The polymerization reaction was conducted with varying amounts of reagents.

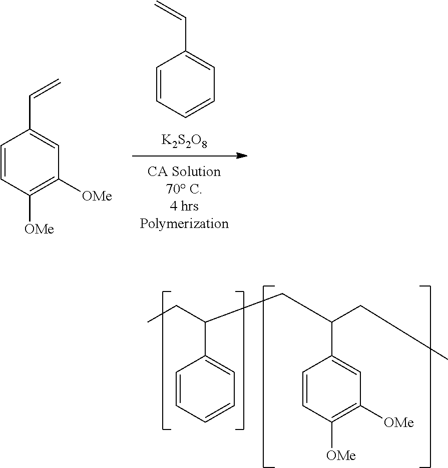

TABLE 1
Reagent amounts

| | DMS | Styrene | | | | | | |
|---|---|---|---|---|---|---|---|---|
| | Scale | Scale | 30 mM | | Initiator | | | |
| Example | (mL) | (mL) | CA (L) | CTA | (g) | M_{w} | PD | Yield |
| 4-1 | 255 | 545 | 2.5 | ½% | 20.3 | 79 k | 2 | 732 g |
| | | | | | | | | (92%) |
| 4-2 | 145 | 310 | 1.4 | 3% | 11.5 | 37 k | 2.4 | 428 g |
| 4-3 | 255 | 545 | 2.5 | ½% | 20.3 | 70 k | 2 | 700-750 g |
| 4-4 | 255 | 545 | 2.5 | ½% | 20.3 | 91 k | 2.5 | 713 g |
| | | | | | | | | (89%) |
| 0058 | 255 | 545 | 2.5 | ½% | 20.3 | 70 k | 1.9 | |
| 0059 | 255 | 545 | 2.5 | ½% | 20.3 | 60 k | 2.2 | |
| 0060 | 255 | 545 | 2.5 | 0.4% | 20.3 | 74 k | 2.3 | |
| 0061 | 255 | 545 | 2.5 | 0.33% | 20.3 | | | |

The surfactant was 10 mM of SDS.

### Example 5 (Comparative)—Deprotection Reactions

The deprotection reaction was conducted with varying amounts of reagents.

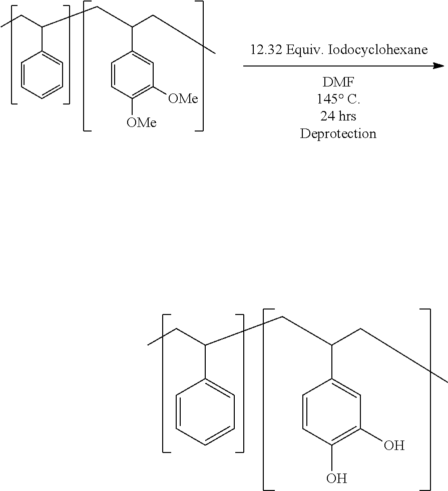

TABLE 2
Reagent amounts

| | | | Iodocyclo- | | | % |
|---|---|---|---|---|---|---|
| | | Scale | hexane | Time | Temp | deprotected |
| Example | PP Mw | (g) | (equivalents) | (hours) | (° C.) | by NMR |
| 5-1 | 80 k* | 720 | 12.3 (Far) | 48 | 110 | 93% |
| 5-2 | 40 k* | 360 | 12.3 (Far) | 48 | 110 | 94% |
| 5-3 | 80 k* | 360 | 12.3 (Far) | 48 | 110 | 93% |
| 5-4 | 80 k* | 250 | 12.3 (Far) | 48 | 110 | 94% |
| 5-5 | 80 k* | 720 | 12.3 (Far) | 48 | 110 | 94% |
| 5-6 | 91 k* | 360 | 12.3 (Far) | 48 | 110 | |
| 5-7 | 167 k* | 60 | 12.3 (Far) | 48 | 110 | |
| 5-8 | 197 k* | 60 | 12.3 (Far) | 48 | 110 | |

*Emulsion

### Example 6—Dry Adhesion Strength

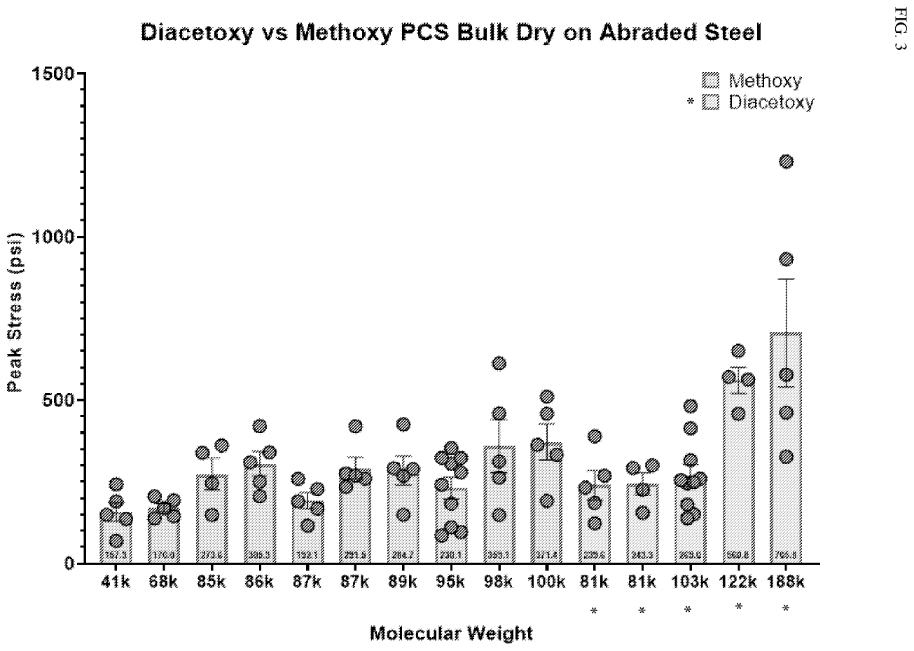

Dry adhesion strength of poly(catechol-styrene) polymer made by processes using diacetoxy and methoxy protecting groups were compared along with their molecular weights. The results are shown in FIG. 3.

### Example 7—Wet Adhesion Strength

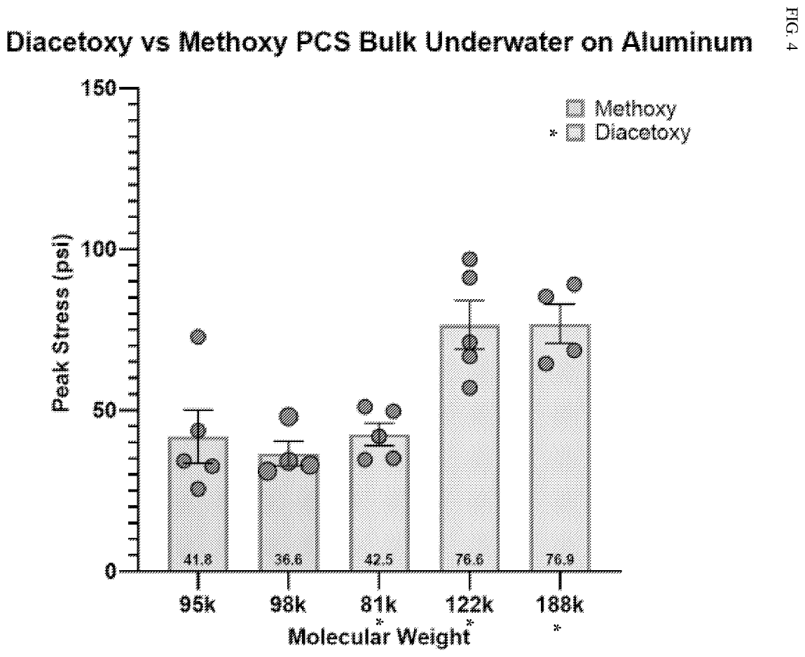

Wet adhesion strength of poly(catechol-styrene) polymer made by processes using diacetoxy and methoxy protecting groups were compared along with their molecular weights. The results are shown in FIG. 4.

### Example 8—Poly(catechol-styrene) Polymer Production Process

The production of (PCS) at pilot scale occurs in three main steps: 1. Monomer Synthesis, 2. Emulsion Polymerization, and 3. Deprotection of the protected polymer to produce PCS.

Monomer Synthesis. In this first step, a 500 L reaction vessel is charged with dimethyl formamide, dispensed from an IBC tote. Caffeic acid powder is added and heated until fully dissolved. Triethyl amine is pumped from a tote to the reactor and heated to 110° C. for two hours. The reactor is then cooled to 25° C. and acetic anhydride is pumped into the reactor. After stirring for 10 hours, the reaction solution is pumped into a storage container. The monomer is isolated by liquid-liquid extraction units. The reaction fluid is diluted with water and extracted with ether. The ether solution of monomer is then treated with 1M HCl followed by a NaCO₃(aq) wash and a NaCl wash. Ether is removed from the purified monomer in an evaporation unit. The ether is then recycled for use in subsequent batches.

Emulsion Polymerization. This second step is the copolymerization of the diacetoxy monomer (DAS), produced in step 1, with commercially acquired styrene in an emulsion process. Sodium lauryl sulfate, cetyl alcohol, potassium persulfate, and sodium bicarbonate are dissolved in water in a 500 L reactor with bubbling nitrogen. Styrene, DAS, and n-dodecylthiol are blended in a 200 L tank with bubbling nitrogen. The monomer blend is added to the 500 L tank and heated to 70° C. for 6 hours under constant agitation. After cooling, the emulsion is transferred to a centrifuge where the water is removed to yield protected polymer powder, poly(3,4-diacetoxystyrene-co-styrene).

Deprotection. This final step performs the deprotection of the protected polymer to produce PCS. A 1000 L reactor is charged with tetrahydrofuran and poly(3,4-diacetoxystyrene-co-styrene) polymer. The reactor is heated to 70° C. and 6M HCl is added. After 24 h, the reaction mixture is cooled and precipitated into a 5000 L tank containing water. The water/THF mixture is drained from the tank, leaving the solid precipitated PCS, and sent to a recovery column allowing for recycling of both the THF and process water for use in subsequent batches. Acetone is sprayed thoroughly throughout the tank to collect all PCS. After the polymer is completely dissolved in the acetone, the solution is filtered and pumped to a storage tank. This solution is then sent to a continuous spray dryer for solvent removal, yielding dry powdered PCS.

### Example 9—PCS Synthesis Results

### Polymerization Reaction

| | | | | | | | | | | | | | Ratio of | Ratio Chain |
|---|---|---|---|---|---|---|---|---|---|---|---|---|---|---|
| | | | | | | | | | Chain | | | Ratio | Co- | Transfer |
| | Water | Surfactant- | Co- | Co- | Catechol | | | | Transfer | | | of SDS | Surfactant | Agent to |
| Batch | Volume | SDS | surfactant | surfactant | monomer | Styrene | Initiator | Initiator | Agent | | | to Total | to Total | Total |
| ID | (L) | (g) | Type | (g) | (g) | (g) | Type | (g) | (g) | MW | PDI | Monomer | Monomer | Monomer |
| DAP0001 | 2.1 | 4.73 | Cetyl | 12.08 | 200 | 286 | Potassium | 12.6 | 1.33 | 25,000 | 2.7 | 0.973% | 2.49% | 0.274% |
| | | | Alcohol | | | | Persulfate | | | | | | | |
| DAP0002 | 2.1 | 4.73 | Cetyl | 12.08 | 200 | 286 | Potassium | 12.6 | 0 | 50,000 | 2.2 | 0.973% | 2.49% | 0.000% |
| | | | Alcohol | | | | Persulfate | | | | | | | |
| DAP0003 | 1.6 | 3.55 | Cetyl | 9.06 | 150 | 214.5 | Potassium | 4.73 | 0 | 40,000 | 2.5 | 0.974% | 2.49% | 0.000% |
| | | | Alcohol | | | | Persulfate | | | | | | | |
| DAP0004 | 1.5 | 4.27 | Cetyl | 10.71 | 196.5 | 281.8 | Potassium | 6.21 | 0 | 700,000 | 5 | 0.893% | 2.24% | 0.000% |
| | | | Alcohol | | | | Persulfate | | | | | | | |
| DAP0005 | 1.5 | 4.26 | Cetyl | 10.7 | 196.5 | 281.8 | Potassium | 15 | 0 | 1,100,000 | 30 | 0.891% | 2.24% | 0.000% |
| | | | Alcohol | | | | Persulfate | | | | | | | |
| DAP0006 | 1.8 | 5.21 | Cetyl | 13.14 | 200 | 286 | Potassium | 6 | 1 | 150,000 | 2.9 | 1.072% | 2.70% | 0.206% |
| | | | Alcohol | | | | Persulfate | | | | | | | |
| DAP0007 | 2 | 5.81 | Cetyl | 14.57 | 200 | 286 | Potassium | 6.03 | 1 | 240,000 | 3.7 | 1.195% | 3.00% | 0.206% |
| | | | Alcohol | | | | Persulfate | | | | | | | |
| DAP0008 | 2 | 11.54 | Cetyl | 29.11 | 200 | 286 | Potassium | 6.04 | 1 | 150,000 | 2.7 | 2.374% | 5.99% | 0.206% |
| | | | Alcohol | | | | Persulfate | | | | | | | |
| DAP0009 | 2.2 | 6.35 | Cetyl | 16.01 | 200 | 286 | Potassium | 6.04 | 1 | 110,000 | 2.9 | 1.307% | 3.29% | 0.206% |
| | | | Alcohol | | | | Persulfate | | | | | | | |
| DAP0010 | 2.2 | 12.75 | Cetyl | 32.05 | 200 | 286 | Potassium | 6.05 | 1 | 137,000 | 2.8 | 2.623% | 6.59% | 0.206% |
| | | | Alcohol | | | | Persulfate | | | | | | | |
| DAP0011 | 2.5 | 7.21 | Cetyl | 18.19 | 200 | 286 | Potassium | 6 | 1 | 105,000 | 3.1 | 1.484% | 3.74% | 0.206% |
| | | | Alcohol | | | | Persulfate | | | | | | | |
| DAP0012 | 2.5 | 14.42 | Cetyl | 36.37 | 200 | 286 | Potassium | 6 | 1 | 150,000 | 3.9 | 2.967% | 7.48% | 0.206% |
| | | | Alcohol | | | | Persulfate | | | | | | | |
| DAP0013 | 2.2 | 6.34 | Cetyl | 16.01 | 200 | 286 | Potassium | 6.04 | 0.5 | 57,000 | 2.5 | 1.305% | 3.29% | 0.103% |
| | | | Alcohol | | | | Persulfate | | | | | | | |
| DAP0014 | 2.2 | 6.33 | Cetyl | 15.98 | 200 | 287 | Potassium | 6.07 | 1.01 | 180,000 | 3.1 | 1.300% | 3.28% | 0.207% |
| | | | Alcohol | | | | Persulfate | | | | | | | |
| DAP0015 | 2.2 | 6.38 | Cetyl | 16.05 | 201 | 243 | Potassium | 6.03 | 1.01 | 168,000 | 3.2 | 1.437% | 3.61% | 0.227% |
| | | | Alcohol | | | | Persulfate | | | | | | | |
| DAP0016 | 2.2 | 6.36 | Cetyl | 16.03 | 198 | 265 | Potassium | 6 | 0.5 | 336,000 | 3.3 | 1.374% | 3.46% | 0.108% |
| | | | Alcohol | | | | Persulfate | | | | | | | |
| DAP0017 | 2.2 | 6.39 | Cetyl | 16.02 | 204 | 287 | Potassium | 5.94 | 0.3 | 196,000 | 3.3 | 1.301% | 3.26% | 0.061% |
| | | | Alcohol | | | | Persulfate | | | | | | | |
| DAP0018 | 2.2 | 6.35 | Cetyl | 16.06 | 200 | 284 | Potassium | 6.08 | 2.04 | 102,000 | 2.7 | 1.312% | 3.32% | 0.421% |
| | | | Alcohol | | | | Persulfate | | | | | | | |
| DAP0019 | 2.2 | 6.36 | Cetyl | 16 | 203 | 280 | Potassium | 6 | 3.01 | 74,000 | 2.8 | 1.317% | 3.31% | 0.623% |
| | | | Alcohol | | | | Persulfate | | | | | | | |
| DAP0020 | 2.2 | 4 | Cetyl | 16.01 | 200 | 225 | Potassium | 5.98 | 3.1 | 55,000 | 4 | 0.941% | 3.77% | 0.729% |
| | | | Alcohol | | | | Persulfate | | | | | | | |
| DAP0021 | 2.2 | 6.35 | Cetyl | 16.02 | 200 | 285 | Potassium | 6.07 | 2.51 | 95,000 | 3 | 1.309% | 3.30% | 0.518% |
| | | | Alcohol | | | | Persulfate | | | | | | | |
| DAP0022 | 2.2 | 6.5 | Cety | 16.14 | 201 | 260 | Potassium | 6.06 | 2.5 | 91,000 | 2.9 | 1.410% | 3.50% | 0.542% |
| | | | Alcohol | | | | Persulfate | | | | | | | |
| DAP0023 | 2.2 | 6.36 | Cetyl | 15.98 | 210 | 285 | Potassium | 6 | 2.81 | 93,000 | 2.7 | 1.285% | 3.23% | 0.568% |
| | | | Alcohol | | | | Persulfate | | | | | | | |
| DAP0024 | 2.2 | 6.27 | Cetyl | 16.02 | 201 | 381 | Potassium | 6.09 | 2.92 | 41,000 | 2.3 | 1.077% | 2.75% | 0.502% |
| | | | Alcohol | | | | Persulfate | | | | | | | |
| DAP0025 | 2.2 | 6.28 | Cetyl | 15.97 | 200 | 289 | Potassium | 6.01 | 2.91 | 65,000 | 2.4 | 1.284% | 3.27% | 0.595% |
| | | | Alcohol | | | | Persulfate | | | | | | | |
| DAP0026 | 2.2 | 6.36 | Cetyl | 16 | 220.2 | | Potassium | 6.05 | | 76,000 | 2.4 | 2.888% | 7.27% | 0.000% |
| | | | Alcohol | | | | Persulfate | | | | | | | |
| DAP0027 | 2.2 | 6.37 | Cetyl | 16.06 | 199.5 | 281 | Potassium | 6.05 | 2.67 | 90,000 | 2.5 | 1.326% | 3.34% | 0.556% |
| | | | Alcohol | | | | Persulfate | | | | | | | |
| DAP0028 | 2.2 | 6.28 | Cetyl | 15.97 | 200 | 284 | Potassium | 6.03 | 2.91 | 97,000 | 2.8 | 1.298% | 3.30% | 0.601% |
| | | | Alcohol | | | | Persulfate | | | | | | | |
| DAP0029 | 2.2 | 6.29 | Cetyl | 16.02 | 203 | 287 | Potassium | 6.05 | 3.02 | 105,000 | 3.1 | 1.284% | 3.27% | 0.616% |
| | | | Alcohol | | | | Persulfate | | | | | | | |
| DAP0030 | 2.2 | 6.32 | Cetyl | 15.99 | 200 | 287 | Potassium | 6.01 | 2.92 | 100,000 | 3 | 1.298% | 3.28% | 0.600% |
| | | | Alcohol | | | | Persulfate | | | | | | | |
| DAP0031 | 2.2 | 6.34 | Cetyl | 16 | 199 | 288 | Potassium | 6.02 | 3.1 | 74,000 | 2.4 | 1.302% | 3.29% | 0.637% |
| | | | Alcohol | | | | Persulfate | | | | | | | |
| DAP0032 | 2.2 | 6.34 | Cetyl | 16.02 | 227 | 288 | Potassium | 5.99 | 3.04 | 99,000 | 2.9 | 1.231% | 3.11% | 0.590% |
| | | | Alcohol | | | | Persulfate | | | | | | | |
| DAP0033 | 2.2 | 6.35 | Cetyl | 16.04 | 200 | 285 | Potassium | 6 | 3.04 | 92,000 | 3.3 | 1.309% | 3.31% | 0.627% |
| | | | Alcohol | | | | Persulfate | | | | | | | |
| DAP0034 | 2.2 | 6.35 | Cetyl | 16 | 205 | 283 | Potassium | 6.03 | 3.04 | 43,000 | 2.1 | 1.301% | 3.28% | 0.623% |
| | | | Alcohol | | | | Persulfate | | | | | | | |
| DAP0035 | 2.2 | 6.36 | Cetyl | 16 | 200.5 | 282 | Potassium | 6.01 | 3.05 | 60,000 | 2.4 | 1.318% | 3.32% | 0.632% |
| | | | Alcohol | | | | Persulfate | | | | | | | |
| DAP0036 | 2.2 | 6.35 | Cetyl | 16 | 200.5 | 282 | Potassium | 6.01 | 3.05 | 64,000 | 2.8 | 1.316% | 3.32% | 0.632% |
| | | | Alcohol | | | | Persulfate | | | | | | | |
| DAP0037 | 2.2 | 6.35 | Cetyl | 16.2 | 200 | 286 | Potassium | 6 | 3.06 | 51,000 | 2.2 | 1.307% | 3.33% | 0.630% |
| | | | Alcohol | | | | Persulfate | | | | | | | |
| DAP0038 | 2.2 | 6.37 | Cetyl | 16.1 | 200 | 286 | Potassium | 6 | 2 | 77,000 | 2.3 | 1.311% | 3.31% | 0.412% |
| | | | Alcohol | | | | Persulfate | | | | | | | |
| DAP0039 | 2.2 | 6.36 | Cetyl | 16.05 | 200 | 286 | Potassium | 6 | 1.81 | 80,000 | 2 | 1.309% | 3.30% | 0.372% |
| | | | Alcohol | | | | Persulfate | | | | | | | |
| DAP0040 | 2.5 | 7.14 | Cetyl | 18 | 225 | 322 | Potassium | 6.74 | 1.81 | 87,000 | 2.2 | 1.305% | 3.29% | 0.331% |
| | | | Alcohol | | | | Persulfate | | | | | | | |
| DAP0041 | 3.3 | 9.54 | Cetyl | 24.02 | 300 | 430 | Potassium | 9.01 | 2.26 | 94,000 | 2.4 | 1.307% | 3.29% | 0.310% |
| | | | Alcohol | | | | Persulfate | | | | | | | |
| DAP0042 | 3.3 | 9.54 | Cetyl | 24.04 | 300 | 430 | Potassium | 9 | 2.5 | 88,000 | 2.4 | 1.307% | 3.29% | 0.342% |
| | | | Alcohol | | | | Persulfate | | | | | | | |
| DAP0043 | 3.3 | 9.53 | Cetyl | 24.04 | 300 | 430 | Potassium | 9 | 2.55 | 99,000 | 2.8 | 1.305% | 3.29% | 0.349% |
| | | | Alcohol | | | | Persulfate | | | | | | | |
| DAP0044 | 3.3 | 9.54 | Cetyl | 24.14 | 300 | 430 | Potassium | 9.01 | 2.5 | 87,000 | 2.5 | 1.307% | 3.31% | 0.342% |
| | | | Alcohol | | | | Persulfate | | | | | | | |
| DAP0045 | 3 | 8.66 | Cetyl | 21.85 | 273 | 390 | Potassium | 8.19 | 2.26 | 84,000 | 2.5 | 1.306% | 3.30% | 0.341% |
| | | | Alcohol | | | | Persulfate | | | | | | | |
| DAP0046 | 3 | 8.66 | Cety | 21.84 | 273 | 390 | Potassium | 8.18 | 2.21 | 103,000 | 3.3 | 1.306% | 3.29% | 0.333% |
| | | | Alcohol | | | | Persulfate | | | | | | | |
| DAP0047 | 3 | 8.66 | Cetyl | 21.83 | 273 | 390 | Potassium | 8.18 | 2.8 | 94,000 | 3.3 | 1.306% | 3.29% | 0.422% |
| | | | Alcohol | | | | Persulfate | | | | | | | |
| DAP0048 | 3 | 8.66 | Cetyl | 21.86 | 273 | 390 | Potassium | 8.18 | 2.8 | 99,000 | 3 | 1.306% | 3.30% | 0.422% |
| | | | Alcohol | | | | Persulfate | | | | | | | |
| DAP0049 | 3 | 8.67 | Cetyl | 21.86 | 273 | 390 | Potassium | 8.2 | 2.8 | 140,000 | 4 | 1.308% | 3.30% | 0.422% |
| | | | Alcohol | | | | Persulfate | | | | | | | |
| DAP0050 | 3 | 8.66 | Cetyl | 21.86 | 273 | 390 | Potassium | 8.18 | 2.01 | 160,000 | 3.4 | 1.306% | 3.30% | 0.303% |
| | | | Alcohol | | | | Persulfate | | | | | | | |
| DAP0051 | 3 | 8.66 | Cetyl | 21.86 | 273 | 390 | Potassium | 8.18 | 1.51 | 300,000 | 6.4 | 1.306% | 3.30% | 0.228% |
| | | | Alcohol | | | | Persulfate | | | | | | | |
| DAP0052 | 3 | 8.66 | Cetyl | 21.86 | 273 | 390 | Potassium | 8.18 | 1.84 | 295,000 | 7 | 1.306% | 3.30% | 0.278% |
| | | | Alcohol | | | | Persulfate | | | | | | | |
| DAP0053 | 3 | 8.66 | Cetyl | 21.86 | 273 | 390 | Potassium | 8.18 | 1.5 | 173,000 | 3.8 | 1.306% | 3.30% | 0.226% |
| | | | Alcohol | | | | Persulfate | | | | | | | |
| DAP0054 | 2.7 | 7.83 | Cetyl | 19.74 | 247 | 353 | Potassium | 7.4 | 2.06 | 177,000 | 3.9 | 1.305% | 3.29% | 0.343% |
| | | | Alcohol | | | | Persulfate | | | | | | | |
| DAP0055 | 2.7 | 7.83 | Cetyl | 19.74 | 247 | 353 | Potassium | 7.4 | 2.06 | 210,000 | 3 | 1.305% | 3.29% | 0.343% |
| | | | Alcohol | | | | Persulfate | | | | | | | |
| DAP0056 | 2.7 | 7.83 | Cetyl | 19.74 | 247 | 353 | Potassium | 7.4 | 0.4 | 204,000 | 3.8 | 1.305% | 3.29% | 0.067% |
| | | | Alcohol | | | | Persulfate | | | | | | | |
| DAP0057 | 3 | 8.66 | Cetyl | 21.86 | 273 | 390 | Potassium | 8.18 | 3.5 | 90,000 | 3 | 1.306% | 3.30% | 0.528% |
| | | | Alcohol | | | | Persulfate | | | | | | | |

### Deprotection Reaction

| | | Protected | | Deprotect. | | | | % | Catechol | Molecular | PDI from |
|---|---|---|---|---|---|---|---|---|---|---|---|
| | Protected | Polymer | Deprotect. | Reagent | Solvent | First | Yield | depro- | content | Weight | Prot. |
| Batch ID | Polymer | Added (g) | Reagent | (mL) | (L) | precip. | (g) | tect. | (%) | (Mw) | Polymer |
| PCS0026 | DAP0006 | 500 | Hydrochloric | 120 | 1.5 | DI | | 100 | 27 | 150000 | 2.9 |
| | | | acid | | | Water | | | | | |
| PCS0027 | DAP0006 | 500 | Hydrochloric | 120 | 1.5 | DI | 58 | 100 | 27 | 150000 | 2.9 |
| | | | acid | | | Water | | | | | |
| PCS0028 | DAP0007 | 500 | Hydrochloric | 120 | 1.5 | DI | 195 | 100 | 25 | 240000 | 3.7 |
| | | | acid | | | Water | | | | | |
| PCS0029 | DAP0008 | 750 | Hydrochloric | 180 | 2.3 | DI | 197.5 | 95 | 27 | 150000 | 2.7 |
| | | | acid | | | Water | | | | | |
| PCS0030 | DAP0009 | 750 | Hydrochloric | 180 | 2.3 | DI | 212.5 | 95 | 27 | 110000 | 2.9 |
| | | | acid | | | Water | | | | | |
| PCS0031 | DAP0012 | 750 | Hydrochloric | 120 | 1.5 | DI | 157 | 95 | 23 | 150000 | 3.9 |
| | | | acid | | | Water | | | | | |
| PCS0032 | DAP0008 | 555 | Hydrochloric | 133 | 1.7 | DI | 233.5 | 100 | 27 | 150000 | 2.7 |
| | | | acid | | | Water | | | | | |
| PCS0033 | DAP0007 | 329 | Hydrochloric | 80 | 1 | DI | 210 | 100 | 25 | 240000 | 3.7 |
| | | | acid | | | Water | | | | | |
| PCS0034 | DAP0010 | 750 | Hydrochloric | 180 | 2.2 | DI | 328 | 100 | 26 | 137000 | 2.8 |
| | | | acid | | | Water | | | | | |
| PCS0035 | DAP0012 | 750 | Hydrochloric | 180 | 2.2 | DI | 163.5 | 100 | 23 | 150000 | 3.9 |
| | | | acid | | | Water | | | | | |
| PCS0036 | DAP0011 | 750 | Hydrochloric | 180 | 2.2 | DI | 248.5 | 100 | 26 | 105000 | 3.1 |
| | | | acid | | | Water | | | | | |
| PCS0037 | BTv5P67 | 750 | Hydrochloric | 180 | 2.2 | DI | 374 | 100 | 23 | 118000 | 2.3 |
| | | | acid | | | Water | | | | | |
| PCS0038 | DAP0016 | 750 | Hydrochloric | 180 | 2.2 | DI | 158 | 95 | 26 | 336000 | 3.3 |
| | | | acid | | | Water | | | | | |
| PCS0039 | DAP0015 | 437 | Hydrochloric | 120 | 1.5 | DI | 380 | 100 | 26 | 168000 | 3.2 |
| | | | acid | | | Water | | | | | |
| PCS0040 | DAP0016 | 750 | Hydrochloric | 180 | 2.2 | DI | 181 | 95 | 26 | 336000 | 3.3 |
| | | | acid | | | Water | | | | | |
| PCS0041 | DAP0013 | 646 | Hydrochloric | 180 | 2.2 | DI | 417 | 95 | 23 | 57000 | 2.5 |
| | | | acid | | | Water | | | | | |
| PCS0042 | DAP0018 | 750 | Hydrochloric | 180 | 2.2 | DI | 152.5 | 90 | 23 | 102000 | 2.7 |
| | | | acid | | | Water | | | | | |
| PCS0043 | DAP0019 | 720 | Hydrochloric | 180 | 2.2 | DI | 336.5 | 95 | 26 | 74000 | 2.8 |
| | | | acid | | | Water | | | | | |
| PCS0044 | DAP0006, | 563 | Hydrochloric | 140 | 1.8 | DI | 243 | 100 | 25 | 150000 | 3.4 |
| | DAP0012 | | acid | | | Water | | | | | |
| PCS0045 | DAP0021 | 750 | Hydrochloric | 180 | 2.2 | DI | 243.5 | 95 | 23 | 95000 | 3 |
| | | | acid | | | Water | | | | | |
| PCS0046 | DAP0021 | 568 | Hydrochloric | 140 | 1.8 | DI | 224 | 95 | 23 | 95000 | 3 |
| | | | acid | | | Water | | | | | |
| PCS0047 | DAP0022 | 750 | Hydrochloric | 180 | 2.2 | DI | 386 | 95 | 24 | 91000 | 2.9 |
| | | | acid | | | Water | | | | | |
| PCS0048 | DAP0023 | 750 | Hydrochloric | 180 | 2.2 | DI | 283 | 95 | 23 | 93000 | 2.7 |
| | | | acid | | | Water | | | | | |
| PCS0049 | DAP0018 | 250 | Hydrochloric | 60 | 0.8 | DI | 205 | 100 | 23 | 102000 | 2.7 |
| | | | acid | | | Water | | | | | |
| PCS0050 | DAP0026 | 750 | Hydrochloric | 180 | 2.2 | DI | 356.5 | 100 | 23 | 76000 | 2.4 |
| | | | acid | | | Water | | | | | |
| PCS0051 | DAP0025 | 750 | Hydrochloric | 180 | 2.2 | DI | 249 | 95 | 24 | 65000 | 2.4 |
| | | | acid | | | Water | | | | | |
| PCS0052 | DAP0017 | 420 | Hydrochloric | 120 | 1.5 | DI | 373.5 | 100 | 22 | 196000 | 3.3 |
| | | | acid | | | Water | | | | | |
| PCS0053 | DAP0027 | 750 | Hydrochloric | 180 | 2.2 | DI | 276.5 | 95 | 24 | 90000 | 2.5 |
| | | | acid | | | Water | | | | | |
| PCS0054 | DAP0028 | 750 | Hydrochloric | 180 | 2.2 | DI | 371 | 100 | 23 | 97000 | 2.8 |
| | | | acid | | | Water | | | | | |
| PCS0055 | DAP0029 | 720 | Hydrochloric | 180 | 2.2 | DI | 387 | 100 | 23 | 105000 | 3.1 |
| | | | acid | | | Water | | | | | |
| PCS0056 | DAP0030 | 750 | Hydrochloric | 180 | 2.2 | DI | 387.5 | 100 | 23 | 100000 | 3 |
| | | | acid | | | Water | | | | | |
| PCS0057 | DAP0031 | 750 | Hydrochloric | 180 | 2.2 | DI | 358 | 95 | 24 | 74000 | 2.4 |
| | | | acid | | | Water | | | | | |
| PCS0058 | DAP0032 | 750 | Hydrochloric | 180 | 2.2 | DI | 385.5 | 100 | 23 | 99000 | 2.9 |
| | | | acid | | | Water | | | | | |
| PCS0059 | DAP0033 | 750 | Hydrochloric | 180 | 2.2 | DI | 311 | 100 | 24 | 92000 | 3.3 |
| | | | acid | | | Water | | | | | |
| PCS0060 | DAP0011, | 709 | Hydrochloric | 180 | 2.2 | DI | 503 | 100 | 24 | 98400 | 2.9 |
| | DAP0023, | | acid | | | Water | | | | | |
| | DAP0027, | | | | | | | | | | |
| | DAP0029, | | | | | | | | | | |
| | DAP0032 | | | | | | | | | | |
| PCS0061 | DAP0035 | 750 | Hydrochloric | 180 | 2.2 | DI | 213 | 95 | 22 | 60000 | 2.4 |
| | | | acid | | | Water | | | | | |
| PCS0062 | DAP0036 | 750 | Hydrochloric | 180 | 2.2 | DI | 325 | 100 | 25 | 64000 | 2.8 |
| | | | acid | | | Water | | | | | |
| PCS0063 | DAP0037 | 750 | Hydrochloric | 180 | 2.2 | DI | 317 | 100 | 23 | 51000 | 2.2 |
| | | | acid | | | Water | | | | | |
| PCS0064 | DAP0038 | 900 | Hydrochloric | 220 | 2.7 | DI | 29 | 95 | 26 | 77000 | 2.3 |
| | | | acid | | | Water | | | | | |
| PCS0065 | DAP0039 | 482 | Hydrochloric | 120 | 1.5 | DI | 408 | 100 | 23 | 80000 | 2 |
| | | | acid | | | Water | | | | | |
| PCS0066 | DAP0040 | 750 | Hydrochloric | 180 | 2.2 | DI | 314.5 | 100 | 26 | 87000 | 2.2 |
| | | | acid | | | Water | | | | | |
| PCS0067 | BTV5P65 | 550 | Hydrochloric | 130 | 1.7 | DI | 360 | 100 | 25 | 100000 | 2.7 |
| | | | acid | | | Water | | | | | |
| PCS0068 | DAP0041 | 750 | Hydrochloric | 180 | 2.2 | DI | 375 | 100 | 23 | 94000 | 2.4 |
| | | | acid | | | Water | | | | | |
| PCS0069 | DAP0042 | 750 | Hydrochloric | 180 | 2.2 | DI | 438 | 100 | 23 | 88000 | 2.4 |
| | | | acid | | | Water | | | | | |
| PCS0070 | DAP0033, | 750 | Hydrochloric | 180 | 2.2 | DI | 530 | 95 | 23 | 91333 | 2.7 |
| | DAP0041, | | acid | | | Water | | | | | |
| | DAP0042 | | | | | | | | | | |
| PCS0071 | DAP0025, | 750 | Hydrochloric | 180 | 2.2 | DI | 538 | 100 | 25 | 78500 | 2.5 |
| | DAP0031, | | acid | | | Water | | | | | |
| | DAP0026, | | | | | | | | | | |
| | DAP0038, | | | | | | | | | | |
| | DAP0040, | | | | | | | | | | |
| | DAP0033 | | | | | | | | | | |
| PCS0072 | DAP0043 | 750 | Hydrochloric | 180 | 2.2 | DI | 540 | 100 | 24 | 99000 | 2.8 |
| | | | acid | | | Water | | | | | |
| PCS0073 | DAP0044 | 750 | Hydrochloric | 180 | 2.2 | DI | 611 | 100 | 24 | 87000 | 2.5 |
| | | | acid | | | Water | | | | | |
| PCS0074 | DAP0045 | 750 | Hydrochloric | 180 | 2.2 | DI | 292 | 100 | 26 | 84000 | 2.5 |
| | | | acid | | | Water | | | | | |
| PCS0075 | DAP0045 | 750 | Hydrochloric | 180 | 2.2 | DI | 325 | 100 | 26 | 84000 | 2.5 |
| | | | acid | | | Water | | | | | |
| PCS0076 | DAP0047 | 750 | Hydrochloric | 180 | 2.2 | DI | 412 | 100 | 25 | 94000 | 3.3 |
| | | | acid | | | Water | | | | | |
| PCS0077 | DAP0048 | 620 | Hydrochloric | 150 | 1.9 | DI | 621 | 100 | 24 | 99000 | 3 |
| | | | acid | | | Water | | | | | |

1. A method of forming a poly(catechol-styrene) polymer comprising the steps of:
(i) polymerizing 3,4-diacetoxystyrene (DAS) monomer and styrene monomer in an emulsion polymerization reaction to form a poly(3,4-diacetoxystyrene-co-styrene) polymer, and
(ii) deprotecting the acetate groups of the resulting poly(3,4-diacetoxystyrene-co-styrene) polymer to form poly(catechol-styrene) polymer.

2. The method of claim 1, wherein the weight ratio of styrene monomer to DAS monomer used in the emulsion polymerization reaction of step (i), wherein the weight ratio is between about 0.1 to about 5.0 or is between about 1.1 to about 1.9.

3. (canceled)

4. The method of claim 1, wherein the emulsion polymerization reaction of step (i) comprises styrene monomer, DAS monomer, a surfactant, an initiator, and a chain transfer agent; where the surfactant comprises one or more of: sodium lauryl sulfate, cetyl alcohol, or a mixture of sodium lauryl sulfate and cetyl alcohol.

5. (canceled)

6. (canceled)

7. (canceled)

8. The method of claim 4, wherein the weight ratio of sodium lauryl sulfate (SLS) to total monomer (styrene+DAS), wherein the weight ratio expressed as a percentage, is between about 0.2% to about 6.0% or between about 0.8% to about 3.0%, wherein the percentage is calculated as (weight of SLS)/(weight of DAS+weight of styrene)*100; and/or comprising a weight ratio of cetyl alcohol to total monomer (styrene+DAS), wherein the weight ratio expressed as a percentage, is between about 0.5% to about 10.0% or between about 2.0% to about 7.0%, wherein the percentage is calculated as (weight of cetyl alcohol)/(weight of DAS+weight of styrene)*100; and/or comprising a weight ratio of cetyl alcohol to sodium lauryl sulfate, wherein the weight ratio is between about 2.0 and about 4.0 or between about 2.30 and about 2.80.

9. (canceled)

10. (canceled)

11. (canceled)

12. (canceled)

13. (canceled)

14. The method of claim 4, wherein the initiator is a water-soluble free radical initiators, wherein the ratio of initiator to total monomer, expressed as a percentage, is between about 0.1% to about 3.0% or between about 1.0%-about 3.0%, wherein the percentage is calculated as (weight of initiator)/(weight of DAS+weight of styrene)*100.

15. (canceled)

16. (canceled)

17. The method of claim 4, wherein the initiator is sodium persulfate, potassium persulfate, ammonium persulfate, benzoyl peroxide, or t-butyl hydroperoxide.

18. The method of claim 4, wherein the chain transfer agent is dodecyl thiol (also known as dodecyl mercaptan or n-dodecanethiol), carbon tetrachloride, or a halocarbon, and wherein the ratio of chain transfer agent to total monomer, expressed as a percentage, is between about 0.05% to about 10%, wherein the percentage is calculated as (weight of chain transfer agent)/(weight of DAS+weight of styrene)*100.

19. (canceled)

20. (canceled)

21. The method of claim 1, wherein the emulsion polymerization reaction (i): further comprises a buffer, such as sodium bicarbonate; further comprises an aqueous solvent, such as water; or further comprises a buffer, such as sodium bicarbonate and an aqueous solvent, such as water; wherein the amount of water used in the emulsion polymerization reaction, as a function of the total monomer used, is about 190-about 320 grams of total monomer per liter of water.

22. (canceled)

23. (canceled)

24. The method of claim 1, wherein the emulsion polymerization reaction: is conducted at an elevated temperature from about 40° C. to about 100° C.; is conducted in an argon or nitrogen atmosphere; is conducted in an argon or nitrogen atmosphere; and/or is stirred at elevated temperature for a period of time of about 3-8 hrs.

25. (canceled)

26. (canceled)

27. (canceled)

28. The method of claim 1, wherein the poly(3,4-diacetoxystyrene-co-styrene) polymer is isolated from the polymerization reaction mixture, wherein the poly(3,4-diacetoxystyrene-co-styrene) polymer is isolated from the polymerization reaction mixture by precipitation and filtration, wherein the precipitation comprises one or more of precipitation by cooling the polymerization reaction mixture; precipitation by mixing the polymerization reaction mixture with a salt solution; precipitation by mixing the polymerization reaction mixture with a salt solution; and/or precipitation by cooling the polymerization reaction mixture and mixing with a salt solution.

29. (canceled)

30. (canceled)

31. (canceled)

32. (canceled)

33. (canceled)

34. The method of claim 1, wherein the poly(3,4-diacetoxystyrene-co-styrene) polymer is precipitated by cooling the polymerization reaction mixture, and then isolated by transferring the mixture to a centrifuge where the water is removed to yield protected polymer powder.

35. The method of claim 1, wherein the poly(3,4-diacetoxystyrene-co-styrene) polymer produced by the emulsion polymerization has a molecular weight in the range of about 25,000 to about 1,100,000 or about 25,000 to about 300,000.

36. (canceled)

37. The method of claim 1, wherein the poly(3,4-diacetoxystyrene-co-styrene) polymer produced by the emulsion polymerization has a polydisperity index (PDI) of about 2 to about 30 or from about 2 to about 4.

38. (canceled)

39. The method of claim 1, wherein the emulsion polymerization reaction results in the conversion of at least 95% of the total monomer (DAS+styrene) to polymer.

40. The method of claim 1, wherein the deprotection reaction, step (ii), is performed by:
treating the poly(3,4-diacetoxystyrene-co-styrene) polymer with aqueous acid, wherein the aqueous acid is selected from hydrochloric acid (HCl), p-toluene sulfonic acid (p-TsOH), fluoroboric acid (HBF₄), camphorsulfonic acid (CSA) and nitric acid, and combinations thereof; or treating the poly(3,4-diacetoxystyrene-co-styrene) polymer: with acid in an amount of 0.9 to 1.9 mmol of acid per gram of poly(3,4-diacetoxystyrene-co-styrene) polymer; or with acid in an amount of 1.4 to 1.5 mmol of acid per gram of poly(3,4-diacetoxystyrene-co-styrene) polymer; and/or wherein the acid is added to the deprotection reaction as a 1M-8M solution; or
treating the poly(3,4-diacetoxystyrene-co-styrene) polymer: with acid in an amount of 0.9 to 1.9 mmol of acid per gram of poly(3,4-diacetoxystyrene-co-styrene) polymer or with acid in an amount of 1.4 to 1.5 mmol of acid per gram of poly(3,4-diacetoxystyrene-co-styrene) polymer;
wherein the deprotection reaction comprises dissolving the poly(3,4-diacetoxystyrene-co-styrene) polymer in a solvent, wherein the solvent is acetone, THF or dimethylformamide (DMF); and/or wherein the poly(3,4-diacetoxystyrene-co-styrene) polymer is dissolved in the solvent at a concentration of 280-500 grams of poly(3,4-diacetoxystyrene-co-styrene) polymer per liter of solvent; and/or
wherein the deprotection reaction is performed by heating the reaction mixture to an elevated temperature, wherein the elevated temperature comprises a temperature in the range of from about 40° C. to about 100° C., or about 70° C.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. The method of claim 40, wherein after deprotection the deprotection reaction mixture is neutralized by addition of a base, such as sodium bicarbonate.

54. The method of claim 1, wherein the poly(catechol-styrene) polymer is isolated by precipitation and filtration; wherein the precipitation comprises cooling the deprotection reaction mixture to about 25-35° C. and then adding a solvent, such as water, to the reaction mixture; adding of a non-polar solvent, such as hexane or ether, by removing the solvent be evaporation, and/or by spray drying to provide the solid poly(catechol-styrene) polymer; or both; and wherein the filtration comprises: re-dissolving the precipitated poly(catechol-styrene) polymer in a polar solvent, such as, acetone, dichloromethane, methyl ethyl ketone, and DMF.

55. (canceled)

56. (canceled)

57. (canceled)

58. (canceled)

59. (canceled)

60. (canceled)

61. (canceled)

62. The method of claim 1, wherein the poly(catechol-styrene) polymer produced by the method has a molecular weight ranging from 15,000 to 1,000,000, or from about 50,000 to about 400,000, as measured by GPC; has a polydispersity index (PDI) of about 1 to about 4, as measured by GPC; or both.

63. (canceled)

64. (canceled)

65. A polymerization reaction end-product comprising poly(3,4-diacetoxystyrene-co-styrene) polymer, wherein the unconverted monomer present in the reaction end product is one or more selected from: less than 5% of the monomer that was added to the reaction mixture, less than 1% of the monomer that was added to the reaction mixture, and is less than 0.5% of the monomer that was added to the reaction mixture.

66. (canceled)

67. (canceled)

68. A polymerization reaction end-product comprising PCS polymer, wherein the unconverted monomer present in the reaction mixture is less than 5% of the monomer that was added to the reaction mixture, less than 1% of the monomer that was added to the reaction mixture, or less than 0.5% of the monomer that was added to the reaction mixture.

69. (canceled)

70. (canceled)
